(19) United States
(12) Patent Application Publication
(10) Pub. No.: US 2026/0116798 A1
(43) Pub. Date: Apr. 30, 2026

(54) EFFECTIVE TREATMENT OF CHLOROTRIFLUOROETHYLENE (CTFE) OLIGOMERS AND DERIVATIVES

(71) Applicant: The Regents of the University of California, Oakland, CA (US)

(72) Inventors: Yujie Men, Riverside, CA (US); Bosen Jin, Riverside, CA (US); Yiwen Zhu, Riverside, CA (US)

(21) Appl. No.: 19/067,720

(22) Filed: Feb. 28, 2025

Related U.S. Application Data
(60) Provisional application No. 63/560,398, filed on Mar. 1, 2024.

(51) Int. Cl. C02F 3/34; C02F 3/30; C02F 101/36

(52) U.S. Cl. CPC C02F 3/341; C02F 3/30; C02F 3/301; C02F 2101/36; C02F 2209/29; C02F 2305/06

(57) ABSTRACT

Methods of biodegrading chlorotrifluoroethylene (CTFE) oligomers, oligomer acids, and derivatives thereof, are described. One example method of biodegrading CTFE oligomers, oligomer acids, and derivatives thereof utilizes Desulfovibrio aminophilus and Sporomusa sphaeroides. Examples of the method provide increased overall degradation of CTFE oligomers, oligomer acids, and derivatives thereof, in wastewater.

### CROSS-REFERENCE TO RELATED APPLICATIONS

This application claims the benefit of U.S. Provisional Patent Application No. 63/560,398, entitled “BIODEGRADATION OF CHLOROTRIFLUOROETHYLENE OLIGOMERS AND DERIVATIVES,” filed on Mar. 1, 2024, which is incorporated herein by reference in its entirety.

### STATEMENT REGARDING FEDERALLY SPONSORED RESEARCH

This invention was made with government support under Contract No. W912HQ20C0033 awarded by the Department of Defense and Contract No. R01ES032668 awarded by the National Institute of Environmental Health Sciences.

### TECHNICAL FIELD

This patent document relates to biological environmental remediation, specifically wastewater decontamination.

### BACKGROUND

Polychlorofluoroalkyl compounds represent a large group of per- and polyfluoroalkyl substances (PFAS), which have found widespread use in commercial products and industrial materials. Well-known examples include fluoropolymers such as polychlorotrifluoroethylene (PCTFE) and chlorotrifluoroethylene (CTFE) oligomers contained in non-flammable engineered fluids. The thermolysis of PCTFE and metabolism of CTFE oligomers by higher organisms can generate CTFE oligomer carboxylic acids. They may enter into the hydrosphere together with other chlorinated PFAS (Cl-PFAS) and ultra-short chain chlorofluorocarboxylic acids used as building blocks for PFAS synthesis or derived from chlorofluorocarbons, causing adverse impacts on the ecosystem.

Despite the increasing detection of Cl-PFAS in diverse natural and engineered environments, including surface run-off, lakes, sediments, and wastewater treatment plants (WWTP), their biodegradability and environmental fate are not well documented. Studies on the transformations of Cl-PFAS by microbes and higher organisms have been limited to certain structures. Whether and how environmental microbes defluorinate other important Cl-PFAS, such as CTFE oligomer acids, and how the number and position of Cl substitutions would affect biodegradability are as yet unknown.

Accordingly, there remains a need to degrade Cl-PFAS, such as CTFE derivatives, efficiently.

### SUMMARY

One aspect of the disclosure provided herein relates to a method of biodegrading chlorotrifluoroethylene (CTFE) oligomers, oligomer acids, and derivatives thereof, the method comprising inoculating one or more bacteria into a growth substrate, where the one or more bacteria is selected from the group consisting of Acetobacterium bakii, Acetobacterium malicum, Acetobacterium woodii, Acetobacterium fimetarium, Acetobacterium wieringae, Acetobacterium paludosum, Desulfovibrio aminophilus, and Sporomusa sphaeroides, adding the inoculated growth substrate into a biomass inside a first biological treatment unit, wherein the first biological treatment unit is kept under anaerobic conditions, depositing wastewater into the first biological treatment unit, retaining the wastewater in the first biological treatment unit for a first time period, adding the inoculated growth substrate into a biomass inside a second biological treatment unit, wherein the second biological treatment unit is kept under aerobic conditions, transferring the wastewater from the first biological treatment unit to the second biological treatment unit, retaining the wastewater in the second biological treatment unit for a second time period, and testing the wastewater to determine the concentration of chemical compounds selected from the group consisting of CTFE oligomers, oligomer acids, and derivatives thereof, and/or breakdown products from the biological degradation of CTFE oligomers, oligomer acids, and derivatives thereof.

In some embodiments, the one or more bacteria is one or more of Desulfovibrio spp., Sporomusa spp., and Acetobacterium spp.

In some embodiments, the growth substrate is lactate or fructose. In some embodiments, the growth substrate further comprises sulfate and organic carbon. In some embodiments, the growth substrate further comprises a compound selected from the group consisting of acetate or methanol. In some embodiments, the one or more bacteria are combined with an activated sludge bacterial community taken from a wastewater treatment plant. In some embodiments, the biomass contains an activated sludge bacterial community.

In some embodiments, the first time period is between about 30 days to about 45 days. In some embodiments, the second time period is between about 10 days to about 20 days. In some embodiments, the second time period is between about 5 days to about 15 days.

In some embodiments, the target biodegradation percentage of CTFE oligomers, oligomer acids, and derivatives thereof in the wastewater after exiting the first biological treatment unit ranges from about 70% to about 95%. In some embodiments, the target biodegradation percentage of CTFE oligomers, oligomer acids, and derivatives thereof, in the wastewater after exiting the first biological treatment unit ranges from about 80% to about 90%. In some embodiments, the target biodegradation percentage of CTFE oligomers, oligomer acids, and derivatives thereof, in the wastewater after exiting the second biological treatment unit ranges from about 5% to about 20%. In some embodiments, the target biodegradation percentage of CTFE oligomers, oligomer acids, and derivatives thereof, in the wastewater after exiting the second biological treatment unit ranges from about 5% to about 10%.

In some embodiments, the first biological treatment unit is inoculated with a cell culture containing the one or more bacteria. In some embodiments, the first biological treatment unit is inoculated with an autoclaved spent media of the cell culture containing the one or more bacteria. In some embodiments, the first biological treatment unit is inoculated with a cell culture containing the one or more bacteria and an autoclaved spent media of the cell culture containing the one or more bacteria.

In some embodiments, the second biological treatment unit is inoculated with an activated sludge community taken from a wastewater treatment plant.

In some embodiments, the first biological treatment unit and the second biological treatment unit are connected in series. In some embodiments, the first biological treatment unit and the second biological treatment unit are integrated into one unit.

In some embodiments, the first biological treatment unit and/or the second biological treatment unit are connected to an incineration tower. In some embodiments, the first biological treatment unit and/or the second biological treatment unit are linked to a wastewater outlet flow from a commercial or industrial site. In some embodiments, the first biological treatment unit and/or the second biological treatment unit are linked to a wastewater treatment plant. In some embodiments, the first biological treatment unit and/or the second biological treatment unit are linked to a wastewater flow.

In some embodiments, the first biological treatment unit and/or the second biological treatment unit contain a chemical monitoring system. In some embodiments, the wastewater contained within the first biological treatment unit or the second biological treatment unit are tested for residual CTFE oligomers, oligomer acids, derivatives thereof, and degradation byproducts through automated sample removal and/or sample testing. In some embodiments, the wastewater contained within the first biological treatment unit or the second biological treatment unit are tested for residual CTFE oligomers, oligomer acids, derivatives thereof, and degradation byproducts through manual sample removal and/or sample testing.

### BRIEF DESCRIPTION OF THE DRAWINGS

FIG. 1A shows the proposed general biotransformation pathways of chlorotrifluoroethylene (CTFE) oligomer carboxylic acids by an anaerobic microbial community, with green arrows indicating dechlorination reactions and red arrows indicating defluorination reactions.

FIG. 1B shows the parent compound decay and F⁻ formation of CTFE oligomer carboxylic acids by an anaerobic microbial community over a 48-day period.

FIG. 2A shows the decay, formation of fluoride, and transformation products (TP) in the biotransformation and defluorination pathways of CTFE2 by the anaerobic microbial community.

FIG. 2B shows the proposed biotransformation pathways in the biotransformation and defluorination pathways of CTFE2 by the anaerobic microbial community, with green arrows indicating dechlorination reactions and red arrows indicating defluorination reactions.

FIG. 3A shows the decay and formation of TP170 and fluorine ions in the biotransformation and defluorination of CTFE3 by the anaerobic microbial community, with TP170 being quantified with a reference standard.

FIG. 3B shows the decay and formation of TPs in higher peak areas in the biotransformation and defluorination of CTFE3 by the anaerobic microbial community, with TP170 being quantified with a reference standard.

FIG. 3C shows the decay and formation of TPs in lower peak areas in the biotransformation and defluorination of CTFE3 by the anaerobic microbial community, with TP170 being quantified with a reference standard.

FIG. 4 shows the calculated bond dissociation energy (BDE) in kJ/mol for the investigated Cl-PFCAs.

FIGS. 5A and 5B shows the proposed biotransformation pathways for CTFE3 and CTFE4, including proposed key defluorination pathways via hydrolytic dechlorination and chain-shortening reactions for CTFE4.

FIG. 6A shows the proposed biotransformation pathways shared by Cl-C5a, Cl-C7a, and Cl-C9a in the biotransformation of Cl-terminal PFCAs by the anaerobic microbial community, with green arrows indicating dechlorination reactions and red arrows indicating defluorination reactions.

FIG. 6B shows the parent compound decay, F⁻ release, and TP formation from the biotransformation of the Cl-terminal PFCA Cl-C5a by the anaerobic microbial community.

FIG. 6C shows the parent compound decay, F⁻ release, and TP formation from the biotransformation of the Cl-terminal PFCA Cl-C7a by the anaerobic microbial community

FIG. 6D shows the parent compound decay, F⁻ release, and TP formation from the biotransformation of the Cl-terminal PFCA Cl-C9a by the anaerobic microbial community

FIG. 6E shows the sorption of Cl-C9a and its TPs on the active biomass at the end of incubation.

FIG. 7A shows the defluorination through biotransformation of C₂ chlorinated fluorocarboxylic acids and their H-substituted counterparts by the anaerobic microbial community.

FIG. 7B shows the defluorination through biotransformation of C₃ chlorinated fluorocarboxylic acids and their H-substituted counterparts by the anaerobic microbial community

FIG. 7C shows the parent compound removal, F⁻ release, and TP formation in the biotransformation of Cl-C2b and its H-substituted counterparts by the anaerobic microbial community.

FIG. 7D shows the parent compound removal, F⁻ release, and TP formation in the biotransformation of Cl-C3b and its H-substituted counterparts by the anaerobic microbial community

FIG. 7E shows the parent compound removal, F⁻ release, and TP formation in the biotransformation of Cl-C3c and its H-substituted counterparts by the anaerobic microbial community

FIG. 7F shows the proposed biotransformation pathways of Cl-C2b, Cl-C3b, and Cl-C3c in the biotransformation of Cl-C2b, Cl-C3b, and Cl-C3c and their H-substituted counterparts by the anaerobic microbial community.

FIG. 8 shows parent compound decay for Cl-C2a, C2a (DFA), C2c (TFA), and Cl-C3a in the activated sludge community under anaerobic conditions.

FIG. 9A shows the anaerobic biotransformation and defluorination of C2b and C3c by the activated sludge community.

FIG. 9B shows the plausible biotransformation pathways of C2b and C3c, with unstable transient intermediates in brackets and undetected intermediates in dashed boxes.

FIG. 10A shows the biotransformation and fluoride formation of H-PFCAs under anaerobic conditions.

FIG. 10B shows the biotransformation and fluoride formation of PFdiCAs under anaerobic conditions.

FIG. 11A shows the defluorination of 50 μM CTFE4 in subcultures of anaerobic communities.

FIG. 11B shows the defluorination of 50 μM CTFE4 in the colony isolated from the third subculture, with an image of the morphology of the isolated colony and the isolated colony after 40 days' growth.

FIG. 11C shows the total fluoride formation, cell-normalized fluoride formation, and the major stable TPs from CTFE4 (50 μM) formed in S. sphaeroides and D. aminophilus after 40 days.

FIG. 12A shows the CTFE4 biotransformation and defluorination by Sporomusa sphaeroides.

FIG. 12B shows the CTFE4 biotransformation and defluorination by Desulfovibrio aminophilus.

FIG. 12C shows the TPs formed by Sporomusa sphaeroides during the biotransformation and defluorination of CTFE4.

FIG. 12D shows the TPs formed by Desulfovibrio aminophilus during the biotransformation and defluorination of CTFE4.

FIG. 13 shows the total defluorination degree of CTFE4 (100 μM) after 120 days by the fourth subculture of the original CTFE4-defluorinating microcosm with and without the addition of 10 mM sulfate.

FIG. 14 shows a comparison of microbial activity of Cl-PFCA, h_PFCA, PFCA, and PFdiCA (50 μM each dissolved in MilliQ water) on Vibrio fischeri.

FIG. 15 shows the total defluorination degree of 50 μM CTFE4 by the activated sludge community under the anaerobic condition only and the anaerobic community followed by aerobic treatment.

FIG. 16 shows the biotransformation and degradation of CTFE4 by A. bakii, A. malicum, A. woodii, A. fimetarium, A. wieringae, A. paludosum, and C. homopropionicum.

FIG. 17 shows the biotransformation and degradation of Cl-C2bm Cl-C3b, CTFE4, CTFE2, CTFE3, and Cl-C7a by A. bakii and the biotransformation and degradation of CTFE2 and CTFE3 by C. homopropionicum.

FIG. 18 shows the fluoride formation from the alkane form of 50 M CTFE trimer by D. aminophilus and S. sphaeroides.

FIG. 19 shows the defluorination of 100 μM CTFE4 by the spent medium of D. aminophilus.

FIG. 20 shows a comparison of fluorine ions measured by ISE and IC using eight mock samples in circles and four real supernatant samples in squares, where the dashed lines indicated the 10% variation.

FIG. 21 shows the aerobic defluorination of Cl-PFCAs by activated sludge community, where “other Cl-PFCAs mix” includes all Cl-PFCAs investigated apart from Cl-C2c and Cl-C3c.

FIGS. 22A-22L show the parent compound decay and fluoride formation in the abiotic and heat-inactivated biomass controls for Cl-C2a (FIG. 22A), Cl-C2b (FIG. 22B), Cl-C2c (FIG. 22C), Cl-C3a (FIG. 22D), Cl-C3b (FIG. 22E), Cl-C3c (FIG. 22F), Cl-C5a (FIG. 22G), Cl-C7a (FIG. 22H), Cl-C9a (FIG. 22I), CTFE2 (FIG. 22J), CTFE3 (FIG. 22K), and CTFE4 (FIG. 22L).

FIG. 23A shows the fluoride formation from CTFE4 (50 M) by heme b (2 M) in a basal medium containing mineral salts, plus the reducing agent containing 0.2 mM L-cysteine and 0.2 mM sodium sulfide (BAV1).

FIG. 23B shows the fluoride formation from CTFE4 (50 M) by heme b (2 M) in different matrices including MilliQ water (MQ), autoclaved BAV1 containing 2 M heme b, 10 mM NaHCO₃ buffer solution+0.2 mM cysteine (buffer+L-cysteine), 10 mM NaHCO₃ buffer solution+0.2 mM sodium sulfide (buffer+Na₂S), and 10 mM NaHCO₃ buffer solution+both L-cysteine and sodium sulfide (buffer+L-cysteine+Na₂S).

FIG. 24 shows total defluorination achieved by different treatment methods A, B, C, and D.

### DETAILED DESCRIPTION

As used in the specification and claims, the singular form “a,” “an,” and “the” includes plural references unless the context clearly dictates otherwise. It should be understood that the terms “a” and “an” as used herein refer to “one or more” of the enumerated components.

The use of the alternative (e.g., “or”) should be understood to mean either one, both, or any combination thereof of the alternatives.

The term “about” as used herein in the context of a number refers to a range centered on that number and spanning 10% less than that number and 10% more than that number. The term “about” used in the context of a range refers to an extended range spanning 10% less than that the lowest number listed in the range and 10% more than the greatest number listed in the range.

Throughout this disclosure, any concentration range, percentage range, ratio range, or integer range is to be understood to include the value of any integer within the recited range and, when appropriate, fractions thereof (such as one tenth and one hundredth of an integer), unless otherwise indicated. Also, any number range of this disclosure relating to any physical feature, such as polymer subunits, size, or thickness, are to be understood to include any integer within the recited range, unless otherwise indicated. Throughout this disclosure, numerical ranges are inclusive of their recited endpoints, unless specifically stated otherwise.

Unless the context requires otherwise, throughout the present specification and claims, the word “comprise” and variations thereof, such as, “comprises” and “comprising” are to be construed in an open, inclusive sense, that is, as “including, but not limited to.” As used herein, the terms “include” and “comprise” are used synonymously.

Unless specified otherwise, the terms “composition” and “composite” may be used interchangeably.

Unless the context requires otherwise, the term “derivatives” throughout the present specification refers to molecules that are structurally similar to or derive from CTFE.

Disclosed herein is the enhanced anaerobic microbial biotransformations of a comprehensive set of environmentally important Cl-PFAS, as shown below in Tables 1 and 2 by three types of dechlorination reaction. Disclosed herein is hydrolytic dechlorination triggering a substantial defluorination of CTFE trimer and tetramer acids by elucidating the biotransformation and biodefluorination pathways. The structure-biodegradability relationship was explored for the PFAS for select microorganisms and biomolecules. The present disclosure contains new insights into the environmental fate of Cl-PFAS, particularly CTFE oligomer acids, PFAS source tracking, the design of readily biodegradable alternative PFAS and the development of cost-effective biotechnologies of the clean-up of PFAS from impacted environments.

### Microbial CTFE Degradation

One aspect of the disclosure provided herein relates to a method of biodegrading chlorotrifluoroethylene (CTFE) oligomers, oligomer acids, and derivatives thereof, the method comprising inoculating one or more bacteria into a growth substrate, where the one or more bacteria is selected from the group consisting of Acetobacterium bakii, Acetobacterium malicum, Acetobacterium woodii, Acetobacterium fimetarium, Acetobacterium wieringae, Acetobacterium paludosum, Desulfovibrio aminophilus, and Sporomusa sphaeroides, adding the inoculated growth substrate into a biomass inside a first biological treatment unit, wherein the first biological treatment unit is kept under anaerobic conditions, depositing wastewater into the first biological treatment unit, retaining the wastewater in the first biological treatment unit for a first time period, adding the inoculated growth substrate into a biomass inside a second biological treatment unit, wherein the second biological treatment unit is kept under aerobic conditions, transferring the wastewater from the first biological treatment unit to the second biological treatment unit, retaining the wastewater in the second biological treatment unit for a second time period, and testing the wastewater to determine the concentration of chemical compounds selected from the group consisting of CTFE oligomers, oligomer acids, derivatives thereof, and/or breakdown products from the biological degradation of CTFE oligomers, oligomer acids, and/or derivative compounds thereof.

In some embodiments, CTFE oligomers, oligomer acids, and derivatives thereof, are biodegraded with one or more bacteria selected from the group consisting of Acetobacterium bakii, Acetobacterium malicum, Acetobacterium woodii, Acetobacterium fimetarium, Acetobacterium wieringae, Acetobacterium paludosum, Desulfovibrio aminophilus and Sporomusa sphaeroides.

In some embodiments, the one or more bacteria is one or more of Desulfovibrio spp., Acetobacterium spp., and Sporomusa spp.

In some embodiments, the growth substrate for the one or more bacteria is lactate or fructose. In some embodiments, the growth substrate further comprises sulfate and organic carbon. In some embodiments, the growth substrate further comprises a compound selected from the group consisting of acetate and methanol. In some embodiments, the one or more bacteria are combined with an activated sludge bacterial community taken from a wastewater treatment plant. In some embodiments, the biomass contains an activated sludge bacterial community.

In some embodiments, the one or more bacteria are combined with a commercially available biotreatment. In some embodiments, the one or more bacteria are combined with an activated sludge community.

In some embodiments, the target biodegradation percentage of CTFE oligomers, oligomer acids, and derivatives thereof, molecules in the wastewater after exiting the first biological treatment unit ranges from about 55%, 60%, 65%, 70%, 75%, 80%, 85%, 90%, and about 95%. For example, in some embodiments, the target biodegradation percentage of CTFE oligomers, oligomer acids, and derivatives thereof, in the wastewater after exiting the first biological treatment unit ranges from about 70% to about 95%. For example, in some embodiments, the target biodegradation percentage of CTFE oligomers, oligomer acids, and derivatives thereof in the wastewater after exiting the first biological treatment unit ranges from about 80% to about 90%.

In some embodiments, the target biodegradation percentage of CTFE oligomers, oligomer acids, and derivatives thereof, in the wastewater after exiting the first biological treatment unit ranges from about 5%, 10%, 15%, 20%, 25%, 30%, and about 35%. For example, in some embodiments, the target biodegradation percentage of CTFE oligomers, oligomer acids, and derivatives thereof in the wastewater after exiting the second biological treatment unit ranges from about 5% to about 20%. For example, in some embodiments, the target biodegradation percentage of CTFE oligomers, oligomer acids, and derivatives thereof in the wastewater after exiting the second biological treatment unit ranges from about 5% to about 10%.

In some embodiments, the wastewater was retained in the first biological treatment unit for a first time period ranging between about 3 days, 5 days, 7 days, 9 days, 10 days, 15 days, 20 days, 30 days, 35 days, 40 days, 45 days, and about 50 days. For example, in some embodiments, the first time period ranges from about 30 days to about 45 days.

In some embodiments, the wastewater was retained in the second biological treatment unit for a second time period ranging between about 3 days, 5 days, 6 days, 7 days, 8 days, 9 days, 10 days, 11 days, 12 days, 13 days, 14 days, 15 days, 16 days, 17 days, 18 days, 19 days, and about 20 days. For example, in some embodiments, the second time period ranges from about 5 days to about 15 days. in some embodiments, the second time period ranges from about 10 days to about 20 days. In some embodiments, total defluorination of the CTFE oligomers, oligomer acids, and derivatives thereof was seen in about 20 days.

In some embodiments, the first biological treatment unit is inoculated with a cell culture containing the one or more bacteria. In some embodiments, the first biological treatment unit is inoculated with an autoclaved spent media of the cell culture containing the one or more bacteria. In some embodiments, the first biological treatment unit is inoculated with a cell culture containing the one or more bacteria and an autoclaved spent media of the cell culture containing the one or more bacteria.

In some embodiments, the second biological treatment unit is inoculated with an activated sludge community from a wastewater treatment plant.

In some embodiments, the first biological treatment unit and/or the second biological treatment unit are connected to an incineration tower. In some embodiments, the first biological treatment unit and/or the second biological treatment unit are linked to a wastewater outlet flow from a commercial or industrial site. In some embodiments, the first biological treatment unit and/or the second biological treatment unit are linked to a wastewater flow.

In some embodiments, the first biological treatment unit and the second biological treatment unit are connected in series. In some embodiments, the first biological treatment unit and the second biological treatment unit are integrated into one unit.

In some embodiments, the first biological treatment unit and/or the second biological treatment unit contain a chemical monitoring system. In some embodiments, the chemical monitoring system may further comprise one or more analytical tools selected from the group consisting of an HPLC-(HR)MS/MS, and a gas chromatograph.

In some embodiments, the wastewater contained within the first biological treatment unit or the second biological treatment unit are tested for residual CTFE oligomers, oligomer acids, derivatives thereof, and degradation byproducts through automated sample removal and/or sample testing. In some embodiments, the wastewater contained within the first biological treatment unit or the second biological treatment unit are tested for residual CTFE oligomers, oligomer acids, derivatives thereof, and degradation byproducts through manual sample removal and/or sample testing.

In some embodiments, the CTFE oligomers, oligomer acids, and derivatives thereof, are exposed to one or more chemical oxidation reactors. In some embodiments, the one or more chemical oxidation reactors contain one or more ultraviolet (UV) lamps. In some embodiments, the one or more UV lamps emit UV light at 254 nm. In some embodiments, the one or more chemical degradation reactors contain a H₂O₂ solution. In some embodiments, the one or more chemical degradation reactors contain a chemical monitoring system.

Another aspect of the disclosure provided herein relates to a method of biodegrading a chlorotrifluoroethylene (CTFE) oligomer acid, the method comprising combining the CTFE oligomer acid with heme b and a medium comprising sodium sulfide under anaerobic conditions; and maintaining the combination at anaerobic conditions for a period of time sufficient to achieve defluorination of the CTFE oligomer acid.

In some embodiments, combining the CTFE oligomer acid with heme b in the medium comprises adding the heme b to the medium first and then adding the CTFE oligomer to the medium containing the heme b. In some embodiments, the medium containing heme b is heated, such as, for example by autoclaving the medium containing the heme b before adding the CTFE oligomer acid to the medium. In some embodiments, the medium comprising sodium sulfide is BAV1. In some embodiments, the medium is BAV1 and the heme b is added to the BAV1 before adding the CTFE oligomer. In some embodiments, the BAV1 containing the heme b is heated, such as, for example, by autoclaving the BAV1 containing heme b before adding the CTFE oligomer acid to the BAV1.

The amount of defluorination achieved by the method may depend on the amount of time the combination is maintained at anaerobic conditions. For example, maintenance of the combination at anaerobic conditions for one day may result in less defluorination than maintenance of the combination at anaerobic conditions for five days. In some embodiments, the combination is maintained at anaerobic conditions for five days. In such embodiments, the method achieves at least 30% defluorination of the CTFE oligomer acid.

Still another aspect of the disclosure provided herein relates to a method of biodegrading a chlorotrifluoroethylene (CTFE) oligomer, the method comprising treating the CTFE oligomer using an advanced oxidation process (AOP) to produce an AOP treatment product; adding the AOP treatment product into a biomass inside a biological treatment unit maintained under anaerobic conditions; depositing wastewater into the biological treatment unit; retaining the wastewater in the biological treatment unit for a time period; and testing the wastewater to determine the concentration of the CTFE oligomer and/or breakdown products from the biological degradation of the CTFE oligomer.

In some embodiments, the advanced oxidation process comprises combining the CTFE oligomer with a surfactant in persulfate; and heating the combination at basic pH for one to four hours.

In some embodiments, the surfactant is a nonionic surfactant. In some embodiments, the nonionic surfactant is a polysorbate. For example, the nonionic surfactant may be polysorbate 20, polysorbate 40, polysorbate 60, or polysorbate 80. In some embodiments, the surfactant is polysorbate 60. In some embodiments, the surfactant is tween 60.

In some embodiments, the combination of CTFE oligomer and surfactant in persulfate is heated by any means commonly used in advanced oxidation processes. In some embodiments, combination is heated in an autoclave.

In some embodiments, the combination is heated at a pH of 8 to 14. In some embodiments, the combination is heated at a pH of 10 to 14. In some embodiments, the combination is heated at a pH of 12.

In some embodiments, the combination is heated for one to four hours, one to three hours, one to two hours, two to four hours, two to three hours, or three to four hours. In some embodiments, the combination is heated for two hours.

In some embodiments, the CTFE oligomer acid is combined with a commercially available biotreatment. In some embodiments, the CTFE oligomer acid is combined with an activated sludge community.

In some embodiments, the wastewater was retained in the first biological treatment unit for a time period ranging between about 1 day, 2 days, 3 days, 5 days, 7 days, 9 days, 10 days, 15 days, 20 days, 30 days, 35 days, 40 days, 45 days, and about 50 days. For example, in some embodiments, the time period ranges from about 10 days to about 30 days. In some embodiments, the time period is 14 days.

In some embodiments, the method achieves at least 50% defluorination of the CTFE oligomer. For example, the method may achieve at least 50%, at least 55%, at least 60%, at least 65%, at least 70%, at least 75%, at least 80%, at least 85%, at least 90%, or at least 95% defluorination of the CTFE oligomer. In some embodiments, the method achieves at least 70% defluorination of the CTFE oligomer.

### EXAMPLES

The following examples are intended to illustrate various embodiments of the invention. As such, the specific embodiments discussed are not to be constructed as limitations on the scope of the invention. It will be apparent to one skilled in the art that various equivalents, changes, and modifications may be made without departing from the scope of invention, and it is understood that such equivalent embodiments are to be included herein. Further, all references cited in the disclosure are hereby incorporated by reference in their entirety, as if fully set forth herein, to the extent that they do not contradict or are not inconsistent with the instant disclosure.

### Methods and Experimental Setup

### General Methods

The 12 Cl-PFAS, as shown in Table 1, investigated herein were purchased from SynQuest Laboratories, Matrix Scientific, and Manchester Organics. Stock solutions, about 10 mM, of individual Cl-PFAS and reference compounds of plausible TPs, as shown below in Table 2, were prepared in HPLC grade methanol and stored at −20° C.

TABLE 1
Detailed information for investigated C1-polyfluorocarboxylic acids (C1-PFCA)

| | ID | | Purity | RT | LOD | LOQ |
|---|---|---|---|---|---|---|
| Compound* | No.** | Structure (Formula) | (%) | (min) | (mM) | (mM) |
| 2-chloro-2,2-difluoroacetic acid⁽¹⁾ | C1-C2a | 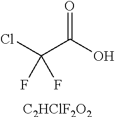 | 97 | 1.34 | 0.07 | 0.1 |
| 2,2-dichloro-2-fluoroacetic acid⁽¹⁾ | C1-C2b | 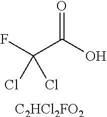 | ≤100 | 1.72 | 0.1 | 0.2 |
| 2-chloro-2-fluoroacetic acid⁽¹⁾ | C1-C2c | 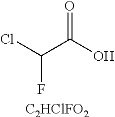 | ≤100 | 1.02 | 0.3 | 0.5 |
| 3-chloro-2,2,3,3- tetrafluoropropionic acid⁽¹⁾ | C1-C3a | 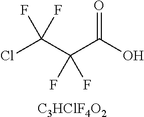 | 97 | 3.32 | 0.1 | 0.2 |
| 2-chloro-2,3,3,3- tetrafluoropropionic acid⁽²⁾ | C1-C3b | 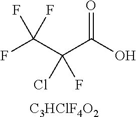 | 99 | 3.47 | 0.1 | 0.2 |
| 2,2-dichloro-3,3,3- trifluoropropionic acid⁽²⁾ | C1-C3c | 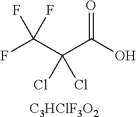 | 95 | 4.62 | 0.2 | 0.7 |
| 3,4-dichloro-2,2,3,4,4,- pentafluorobutanoic acid⁽¹⁾ | CTFE2 | 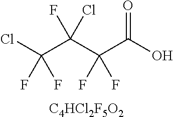 [SMILES: "C4HCl2F5O2" ; O=C(O)C(F)(F)C(F)(Cl)C(F)(F)Cl] | 97 | 5.62 | 0.05 | 0.1 |
| 5-chloro-2,2,3,3,4,4,5,5- octafluoropentanoic acid⁽³⁾ | C1-C5a | 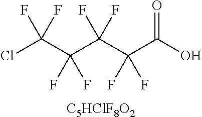 [SMILES: O=C(O)C(F)(F)C(F)(F)C(F)(F)C(F)(F)Cl ; "C5HClF8O2"] | 95 | 6.24 | 0.005 | 0.01 |
| 3,5,6-trichloro-2,2,3,4,4,5,6,6- octafluorohexanoic acid⁽¹⁾ | CTFE3 | 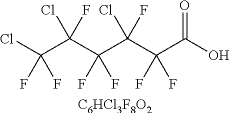 | 95 | 6.75 | 0.05 | 0.1 |
| 7-chloro- 2,2,3,3,4,4,5,5,6,6,7,7- dodecafluoroheptanoic acid⁽¹⁾ | C1-C7a | 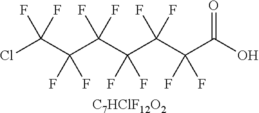 [SMILES: "C7HClF12O2" ; O=C(O)C(F)(F)C(F)(F)C(F)(F)C(F)(F)C(F)(F)C(F)(F)Cl] | 97 | 6.97 | 0.001 | 0.01 |
| 3,5,7,8-tetrachloro- 2,2,3,4,4,5,6,6,7,8,8- undecafluorooctanoic acid⁽¹⁾ | CTFE4 | 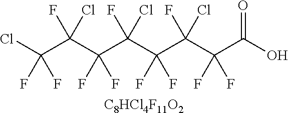 [SMILES: "C8HCl4F11O2" ; O=C(O)C(F)(F)C(F)(Cl)C(F)(F)C(F)(Cl)C(F)(F)C(F)(Cl)C(F)(F)Cl] | 95 | 7.25 | 0.1 | 0.2 |
| 9-chloro- 2,2,3,3,4,4,5,5,6,6,7,7,8,8,9,9- hexadecafluorononanoic acid⁽¹⁾ | C1-C9a | 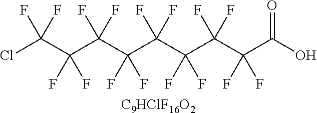 [SMILES: "C9HClF16O2" ; O=C(O)C(F)(F)C(F)(F)C(F)(F)C(F)(F)C(F)(F)C(F)(F)C(F)(F)C(F)(F)Cl] | ≤100 | 7.43 | 0.01 | 0.05 |

*C1-PFCA compounds were purchased from three companies: (1) SynQuest Laboratories, Inc (Alachua, FL,
USA); (2) Matrix Scientific (Columbia, SC, USA); (3) Manchester Organics, Ltd (Runcorn, UK)
**ID numbers were created based on the number of carbons. The lowercase “a” represents that the C1-PFCA
only contains one terminal chlorine.
RT: retention time
LOD: limit of detection
LOQ: limit of quantitation

TABLE 2
Detailed information about H-substituted counterparts of the investigated C1-PFCAs and the standards
of the identified transformation products.

| | | | Purity | RT | LOD | LOQ |
|---|---|---|---|---|---|---|
| Compound* | ID No.** | Structure (Formula) | (%) | (min) | (mM) | (mM) |
| 2,2-difluoroacetic acid⁽¹⁾ | C2a (MFA) | 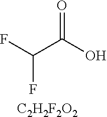 | 98 | 0.91 | 0.05 | 0.1 |
| 2-fluoroacetic acid⁽²⁾ | C1-C2b (DFA) | 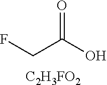 | N/A | 0.88 | 1 | 1.5 |
| 2,2,2-trifluoroacetic acid⁽¹⁾ | TFA | 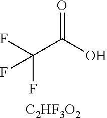 | 99 | 1.1 | 0.01 | 0.05 |
| 2,2,3,3-tetrafluoropropionic acid⁽¹⁾ | C3a | 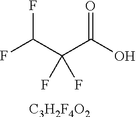 | 97 | 1.31 | 0.001 | 0.01 |
| 2,3,3,3-tetrafluoropropionic acid⁽¹⁾ | C3b | 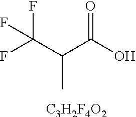 | 97 | 1.23 | 0.005 | 0.01 |
| 3,3,3-trifluoropropionic acid⁽¹⁾ | C3c | 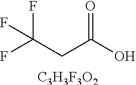 | 97 | 1.14 | 0.05 | 0.5 |
| 2,2,3,3,3,-pentafluoropropionic acid⁽¹⁾ | PFPrA | 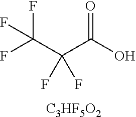 | 98 | 2.22 | 0.001 | 0.05 |
| 2,2,3,3,4,4,-hexafluorobutanoic acid⁽¹⁾ | C4a (H- PFBA) | 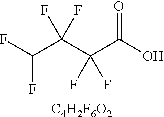 | 97 | 3.01 | 0.001 | 0.005 |
| 2,2,3,3,4,4,4,- heptafluorobutanoic acid⁽¹⁾ | PFBA | 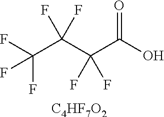 | 98 | 5.07 | 0.001 | 0.01 |
| 2,2,3,3,4,4,5,5- octafluoropentanoic acid⁽¹⁾ | C5a (H- PFPeA) | 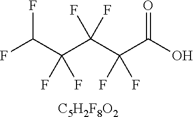 | 97 | 5.25 | 0.001 | 0.01 |
| 2,2,3,3,4,4,5,5,5- nonafluoropentanoic acid⁽¹⁾ | PFPeA | 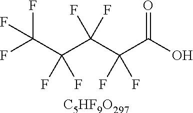 | 98 | 6.1 | 0.001 | 0.01 |
| 2,2,3,3,4,4,5,5,6,6,6- undecafluorohexanoic acid⁽¹⁾ | PFHxA | 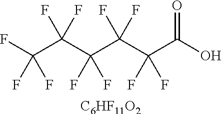 | 97 | 6.59 | 0.001 | 0.01 |
| 2,2,3,3,4,4,5,5,6,6,7,7- dodecafluoroheptanoic acid⁽¹⁾ | C7a (H- PFHpA) | 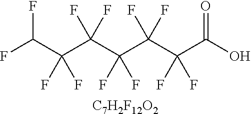 | 98 | 6.38 | 0.005 | 0.05 |
| 2,2,3,3,4,4,5,5,6,6,7,7,7- tridecafluoroheptanoic acid⁽¹⁾ | PFHpA | 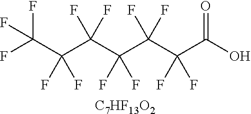 | 97 | 6.93 | 0.005 | 0.01 |
| 2,2,3,3,4,4,5,5,6,6,7,7,8,8- tetradecafluorooctanoic acid⁽¹⁾ | C8a (H- PFOA) | 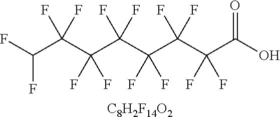 | 97 | 6.66 | 0.001 | 0.005 |
| 2,2,3,3,4,4,5,5,6,6,7,7,8,8,8- pentadecafluorooctanoic acid⁽¹⁾ | PFOA | 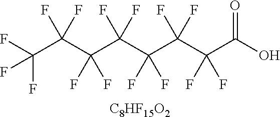 | 98 | 7.18 | 0.001 | 0.005 |
| 2,2,3,3,4,4,5,5,6,6,7,7,8,8,9,9- hexadecafluorononanoic acid⁽¹⁾ | C9a (H- PFNA) | 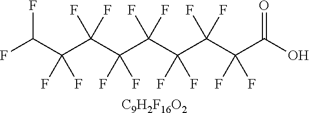 | 97 | 6.92 | 0.005 | 0.01 |
| 2,2,3,3,4,4,5,5,6,6,7,7,8,8,9,9,9- heptadecafluorononanoic acid⁽¹⁾ | PFNA | 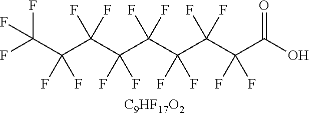 | 97 | 7.4 | 0.0001 | 0.001 |
| Propanedioic acid⁽¹⁾ | Malonic acid | 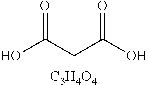 | 100 | 0.85 | 1 | 2 |
| 2,2-difluoromalonic acid⁽¹⁾ | PFPrdiA | 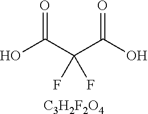 | 98 | 0.82 | 0.05 | 0.5 |
| 2,2,3-trifluorosuccinic acid⁽⁴⁾ | TP170 | 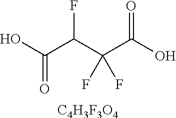 | N/A | 0.84 | 0.01 | 0.1 |
| 2,2,3,3-tetrafluorosuccinic acid⁽¹⁾ | PFBdiA | 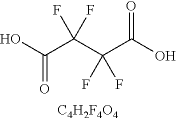 [SMILES: "C4H2F4O4" ; O=C(O)C(F)(F)C(F)(F)C(=O)O] | 98 | 0.81 | 0.005 | 0.01 |
| 2,2,3,3,4,4- hexafluoropentanedioic acid⁽¹⁾ | PFPediA | 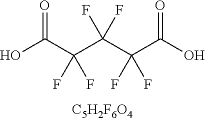 [SMILES: "C5H2F6O4" ; O=C(O)C(F)(F)C(F)(F)C(F)(F)C(=O)O] | 98 | 0.86 | 0.01 | 0.1 |
| 2,2,3,3,4,4,5,5- octafluorohexanedioic acid⁽¹⁾ | PFHxdiA | 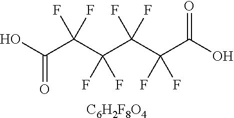 | 97 | 1.12 | 0.01 | 0.05 |
| 2,2,3,3,4,4,5,5,6,6- decafluoroheptanedioic acid⁽¹⁾ | PFHpdiA | 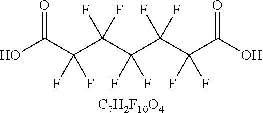 | 90 | N/A | N/A | N/A |
| 2,2,3,3,4,4,5,5,6,6,7,7,8,8- tetradecafluorononanedioic acid⁽¹⁾ | PFNdiA | 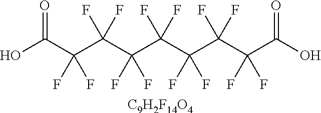 [SMILES: "C9H2F14O4" ; O=C(O)C(F)(F)C(F)(F)C(F)(F)C(F)(F)C(F)(F)C(F)(F)C(F)(F)C(=O)O] | 90 | 5.36 | 0.001 | 0.01 |

*(1) SynQuest Laboratories, Inc (Alachua, FL, USA); (2) Actually, the examined chemical is sodium fluoroacetate (CAS#: 62-74-8) from MP Biomedicals LLC (Irvine, CA, USA); (3) Mcule, Inc. (Palo Alto, CA, USA); (4) Oakwood Products, Inc. (Estill, SC, USA)
**ID numbers were created based on the number of carbons, and common names are provided in the following parentheses.

### Anaerobic Biotransformation

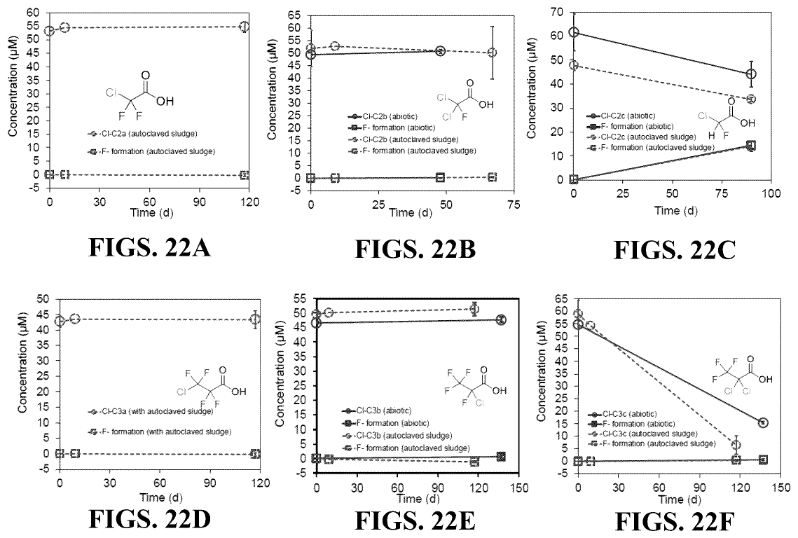

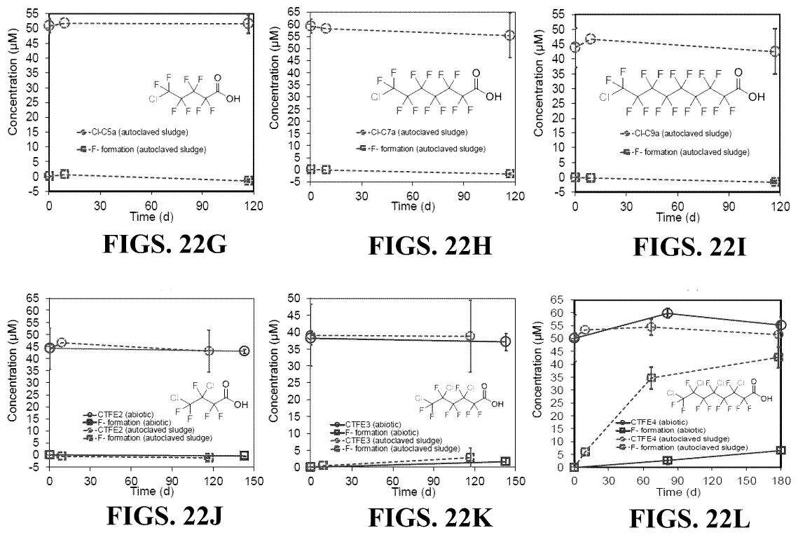

An activated sludge community freshly taken from a local municipal WWTP was used. To avoid the carryover of dissolved oxygen, settled activated sludge (6,700-6,800 mg suspended solids per liter) was inoculated (10%, v/v) into a 160 mL sealed serum bottle containing 90 mL autoclaved basal medium containing vitamins, including 100 μg/L B₁₂ as described in Men et al., ISMEJ. 6, 410-421 (2012), and a 60 mL headspace of Ar/CO₂ (75:25, v/v). Approximately 123 mM methanol was added to the culture as an electron donor and re-added twice a week. About 50 μM of the selected PFAS was added to the culture. The pH of the culture was buffered at 7.4+/−0.1. Biomass-free abiotic and heat-inactivated biomass controls were prepared the same way using autoclaved sludge instead of activated sludge as the inoculum respectively. About 0.2 g/L sodium azide was added to both the abiotic and heat-inactivated biomass controls to further inhibit microbial activities over the entire incubation period. All cultures were incubated in the dark at 34° C. without shaking. The biotransformation experiments with the activated sludge communities and the abiotic and heat-inactivated controls were performed in triplicate. FIGS. 22A-22L show the parent compound decay and fluoride formation in the abiotic and heat-inactivated biomass controls for the twelve investigated Cl-PFCAs. One bottle containing only sludge was also studied as a control for the sludge matrix, which was subtracted in the transformation product (TP) analyses.

Samples, about 2 mL, were removed periodically and centrifuged at 16,000 g at 4° C. for 35 min. The supernatant was collected to measure fluoride, parent compound, and TP content by the following method.

Cell pellets were collected and extracted using 1 mL methanol with 0.1% NH₄OH. The ¹³C-labelled perfluoro-n-octanoic acid-1-¹³C surrogate (CAS #864071-09-0) was spiked to account for extraction recovery. The samples were vortexed and ultrasonicated for 30 min, and then centrifuged at 16,000 g 4° C. for 35 min. The concentrations of parent compounds TPs in the extracted samples were analyzed to account for biomass adsorption. Except for Cl-C9a, which showed substantial biomass adsorption, all tested Cl-PFCAs showed less than 5% adsorption by the biomass. Thus, extracellular concentrations of the parent compounds and TPs were used to interpret biotransformation pathways, except for Cl-C9a and its TPs, for which the total concentrations (extracellular and biomass-associated) were used. The half-lives of the parent compounds were determined by assuming first-order reaction kinetics.

### Aerobic Biotransformation

The aerobic biotransformation were conducted using a similar setup to that used in Che et al., Environ. Sci. Technol. Lett. 8, 668-674 (2021). 50 mL of fresh activated sludge (about 4,400 mg/L as total suspended solids) was inoculated into batch reactors (150 mL, loosely capped) spiked with about 50 μM Cl-PFCA and incubated with shaking (150 r.p.m.) at room temperature for 5 days. The level of dissolved oxygen in the reactors was measured and remained at 4-5 mg/L over the period of the experiments. Heat-inactivated controls were prepared using autoclaved (121° C., 40 min) sludge and autoclaved sludge filtrate (0.22 μm filter). A sludge only control was also analyzed to obtain the F⁻ concentration in the sludge matrix, which did not show any notable change throughout the incubation period.

### Fluoride Measurement

The F⁻ concentration was measured using an HQ30D portable multimeter (HACH) connected to an ion-selective electrode (HACH) with a limit of quantification of 0.01 mg/L, about 0.5 μM. First, 0.1 g fluoride ionic strength adjustor power (HACH) was dissolved in 2 mL of sample. Calibration was conducted by preparing a calibration curve using three standard sodium fluoride solutions (0.5, 1, and 2 mg/L, HACH). Calibration was conducted before each sample measurement. Samples were diluted to the calibration range, as needed, before measurement. The fluoride measurement was cross-validated by ion chromatography (FIG. 20). Fluorine ion formation was calculated by subtracting the F⁻ concentration at time zero to from that at time t. The degree of defluorination was determined using the flowing equation:

$$Degree of defluorination ( \% ) = \frac{{F}^{-} f ormed ( mM )}{removed concentration ( mM ) \times Number of F in one molecule} \times 100 \%$$

### Ultra-High-Performance LC-HRMS Analysis

All organofluorines were analyzed by ultra-high-performance (UHP) LC-HRMS/MS (Q Exactive Plus, Thermo Fisher). For the UHPLC, the mobile phase consisted of 10 mM ammonium acetate in Milli-Q water (eluent A) and 10 mM ammonium acetate in HPLC-grade methanol (eluent B). A 2 μL sample was loaded onto a Hypersil Gold column (particle size 1.9 μm, 2.1 mm×100 mm, Thermo Fisher) and eluted at a flow rate of 300 μL/min. A linear elution gradient was used: 95% A for 0-1 min, 95-5% A for 1-6 min, 5% A for 6-8 min, and 95% A for 8-10 min. For HRMS, negative electrospray ionization was used for sample ionization with a default charge of one. The mass analyzer was set up for both a full mass spectrometry (MS¹) scan (m/z=50-750) at a resolution of 140,000 @m/z=200 and a data-dependent tandem MS (MS²) scan at a resolution of 17,500 @m/z 200 with a normalized collision energy of 25.

The peak areas of all parent compounds and TPs were determined using TraceFinder 4.1 EFS and Freestyle 1.6 (Thermo Fisher). Mass spectrometry data, including MS¹ and MS², were primarily collected with Freestyle 1.6. The concentrations of the parent compounds and TPs with reference standards were determined by establishing external calibration curves using a matrix-match calibration standard series.

### TP Identification and Biotransformation Pathway Elucidation

Suspect screening was conducted using a custom-compiled suspect list that included the possible reductive defluorination and reductive dechlorination products. Non-target screening was also employed for TP analysis using the modified ‘Expected and Unknown Met ID Workflow’ in Compound Discover 3.1 (Thermo Fisher). Plausible TPs were identified using the following criteria: (1) a mass tolerance of ≤5 ppm, (2) a proper peak shape with a peak area larger than 10⁵, (3) an isotopic pattern score of >70, (4) a notable formation trend over time (increasing or increasing followed by decreasing), (5) not detected in the abiotic, heat-inactivated, or sludge only controls, and (6) not identified as in-source fragments. The structures of the plausible TPs were further elucidated from MS² fragmentation profiles. For TPs with reference compounds available, the structures were confirmed by comparing the retention times and MS¹ and MS² profiles of the TP and reference compounds. The confidence levels in the TP identification were determined according to the criteria set by Schymanski et al., Environ. Sci. Technol. 48, 2097-2098 (2014).

Reasonable biotransformation pathways were based on the following three trends: (1) the removal trend of the parent compound, (2) the formation trend of TPs with accurate formula or identified structure, and (3) the formation trend of fluoride. The three trends should be intercorrelated. For example, for biotransformation pathways that include multiple levels of reactions, the TPs from the primary reactions should exhibit a formation trend that first increases, then decreases, followed by the formation of secondary TPs. Generally, primary transient TPs peaked when most of the parent compound had been removed, then the corresponding secondary TPs started to increase substantially; the same applied for the next level of reactions. Stable products (or end products) were those with an increasing trend with a plateau if the precursor was depleted. The formation of fluoride should correspond to the formation of less-fluorinated TPs.

### CTFE4-Defluorinating Subcultures

The original CTFE4-defluorinating anaerobic microcosm obtained from the activated sludge was subcultured (5%, v/v) into the same basal medium containing the same concentrations of methanol and CTFE4. After the defluorination reached the maximum level, about 80%, the last subculture was further transferred (5%, v/v) into the same medium to obtain the subsequent subcultures.

### Anaerobic Isolation

Anaerobic agar shake tubes were used to isolate and purify the colonies from the CTFE4-defluorinating subcultures. First, 10 mL sterile agar medium (0.3-0.5%, w/w) containing the same nutrients (that is, mineral salts, vitamins, methanol, and CTFE4) as in the broth medium was added to each 20-mL sealed glass tube with an N₂ headspace. The tubes were incubated at 45-50° C. before inoculation. After the temperature of the agar medium had decreased slightly, one agar shake tube was inoculated with 1 mL of the third subculture, then gently mixed by inverting the tube several times. Then 1 mL of the mixture was transferred to a new agar shake tube. The contents of a set of inoculated agar shake tubes with 10⁻¹ to 10⁻⁸ serial dilution were solidified at room temperature and incubated at 34° C. After 14 days of incubation, individual colonies were picked up using syringe needles and inoculated into new agar shake tubes for further purification. Further purified individual colonies with different morphology were picked up and transferred into the same liquid basal medium amended with methanol, about 123 mM, and CTFE4 for the defluorination activity test. The liquid cultures from two colonies that showed defluorination activity were subject to metagenomic sequencing for genomic composition analysis.

### Metagenomic Sequencing

Celugation at 18,000 g for 20 min at room temperature, Genomic DNA was extracted using a DNeasy Blood and Tissue kit (Qiagen) according to the manufacturer's instructions and then sent to the Microbial Genome Sequencing Center (Pittsburgh) for sequencing (Illumina NextSeq 2000, 2×150 base pairs, 680×10⁶ base-pair output).

### Reconstruction of Bingenomes

The draft genome assembly and binning were performed using the Department of Energy Systems Biology Knowledgebase (KBase) platform (https://www.kbase.us/). The sequencing reads of each sample were trimmed and quality-filtered using Trimmomatic v0.36 with default parameters. The clean reads were assembled into contigs using MEGAHIT v1.2.9, and the contigs were then binned using MetaBAT v1.7. The quality (that is, completeness and contamination) of the reconstructed bingenomes was assessed using CheckM v1.0.18. Bingenomes with >85% completeness and <5% contamination were considered as successfully reconstructed and subject to downstream analysis. The taxonomic assignment of the reconstructed genomes was assessed using GTDB-TK v1.30, and the genome annotation was generated using RASTtk v1.073. The relative abundance of each reconstructed bingenome was calculated by mapping the quality-filtered sequence reads against the reconstructed bingenome using Bowtie2 v2.3.2. The percentage of mapped reads out of the total reads was regarded as the relative abundance of the reconstructed bingenome.

### CTFE4 Defluorination by Pure Cultures

The two pure cultures, that is, S. sphaeroides and D. aminophilus, were obtained from DSMZ-German Collection of Microorganisms and Cell Cultures under the DSM numbers 2875 and 12254, respectively. Both cultures were maintained in the same basal medium as used for the anaerobic biotransformation by the sludge community, as described above, with the addition of 20 mM sodium lactate as the electron donor. For the sulfate-reducing D. aminophilus, sodium sulfate (2 mM) was also added. For the CTFE4 defluorination test, each culture was inoculated (10%, v/v) into 50 mL of fresh medium containing the same growth substrates and 50 μM CTFE4. After about 40 days, cells were collected by centrifugation at 18,000 g for 20 min at room temperature for DNA extraction to determine the cell density. The supernatant was subjected to F⁻ and CTFE4 analysis.

### Cross-Validation of Fluoride Measurement by Ion Chromatography (IC)

The fluoride measured by the ion-selective electrode (ISE) was cross-validated using a Dionex ICS-5000 ion chromatography system, equipped with a conductivity detector and a Dionex IonPac AS 11-HC column (4×250 mm) with an AG 11-HC guard column (4×50 mm). The column was used at 30° C., with a gradient eluent (1-65 mM KOH) at 1 mL/min and a suppressor current at 161 mA. The difference between the F⁻ concentration measured by the two methods was less than 10% (FIG. 20).

For most of the investigated Cl-PFCAs, no significant abiotic transformation and passive adsorption was observed. For those Cl-PFCAs, the parent compound decay data were fitted into a pseudo first-order reaction model in MATLAB: C=C₀×e^{-kt} where C represents the concentration of the parent compound in micromolar at time t, C₀ is the initial concentration in micromolar, k is the pseudo first-order removal rate constant (d⁻¹), and t is the incubation time. The removal half-life of the parent compound was: t_{1/2}=ln(2)/k.

### Density Functional Theory (DFT) Calculation of Bond Dissociation Energy (BDE)

BDE of C—F and C—Cl bonds were calculated for all examined compounds by the GAUSSIAN 09 software package. All molecular geometries were calculated by the B3LYP/6-311+G(2d,2p) hybrid functional theory. Grimme empirical dispersion correction with the Becke-Johnson damping term (D3-BJ) was added to the calculation for the optimization.

### Determination of Cell Densities in Pure Cultures

Genomic DNA was extracted from cell pellets collected from 10 mL cultures using Qiagen DNeasy Blood and Tissue Kit (Qiagen, Redwood City, CA) according to the manufacturer's instruction. The DNA concentration in the reconstituted 50 μL sample was quantified by Qubit 4.0 (ThermoFisher Scientific, Waltham, MA). The cell density in the 50 mL culture was calculated using the equation below, where N is the copy number per mL, C is the DNA concentration in the reconstituted DNA sample, L is the genome size, which is 4.97 and 3.48 Mbp for Sporomusa sphaeroides and Desulfovibrio aminophilus, respectively.

$$\frac{N ( copy number )}{mL} = \frac{\frac{C ( conc . of DNA sample \frac{mg}{mL} )}{the concentration factor ( 200 )} 6.022 \times {10}^{23} \frac{number}{mole}}{\frac{660 g}{mole} \times \frac{{10}^{6} mg}{g} \times L ( genome size in bp )}$$

Toxicity Test Using Luminescent Bacteria (Vibrio fischeri)

BioTox Watertox Standard Kit (EBPI, Mississauga, ON, Canada) was used to test the toxicity of fluorinated compounds by evaluating the effect of the light emission ability of the typical luminescent bacteria, Vibrio fischeri. The procedure was modified based on the ISO method 11348-3. Briefly, the freeze-dried luminescent bacterial agent was firstly reconstituted in 1 mL of reagent diluent and incubated at 4° C. for at least 30 min. Selected PFAS were diluted in 1 mL Milli-Q water with the final concentration of 50 μM. The sample was then adjusted to reach the pH of 7.0±0.2 and the dissolved oxygen (DO) value above 3 mg/L. The adjusted sample with a series of diluted samples (n=10) and a negative control (sample diluent) with a volume of 150 μL each were transferred to the white 96-well microplate (Fisher Scientific) labeled as Plate A. Each PFAS chemical had a duplicate test.

Bacterial suspension (3 μL) and 150 μL sample diluent (20 g/L of NaCl in Milli-Q water) were transferred to the white 96-well microplate (Fisher Scientific) labeled at Plate B. After another incubation at 20° C.±1° C. for 15 minutes, the inhibitory effect (Et) of a test sample was calculated based on the luminescence strength:

$${E}_{t} \% = ( 1 - \frac{{I}_{t}}{{I}_{o} \times \frac{{I}_{t - NC}}{{I}_{0 - nc}}} ) \times 100 \%$$

where I_{t-NC} and I_{0-NC} were the luminescence values of negative control, Inhibitory effects (Et) versus concentrations (C₁) were plotted in MATLAB (The MathWorks, Natick, MA) and fitted to the adjusted Hill equation to calculate the effective concentration causing 50% luminescence inhibition (EC₅₀) for a PFAS chemical:

$${E}_{t} = {E}_{min} - \frac{{E}_{max} - {E}_{min}}{1 + {( \frac{E {C}_{50}}{{C}_{i}} )}^{n}}$$

where Eₘᵢₙ and Eₘₐₓ were the minimum and maximum effects, and n was the Hill coefficient calculated by the software.

### Example 1: CTFE Oligomer Acid Biotransformation Using Desulfovibrio aminophilus and Sporomusa sphaeroides

### Dechlorination-Induced Defluorination of CTFE Oligomer Acids

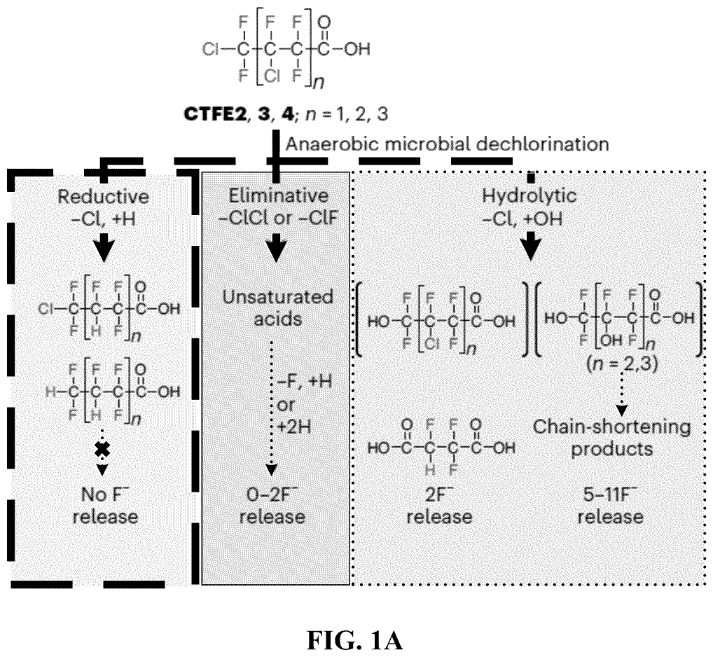

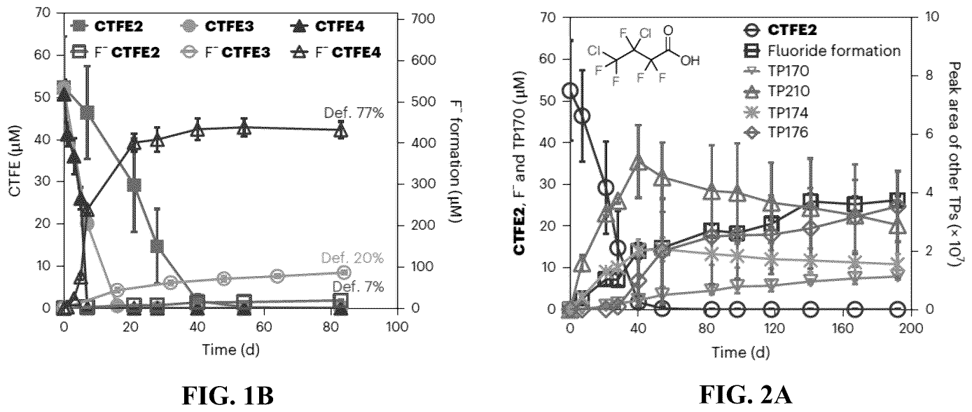

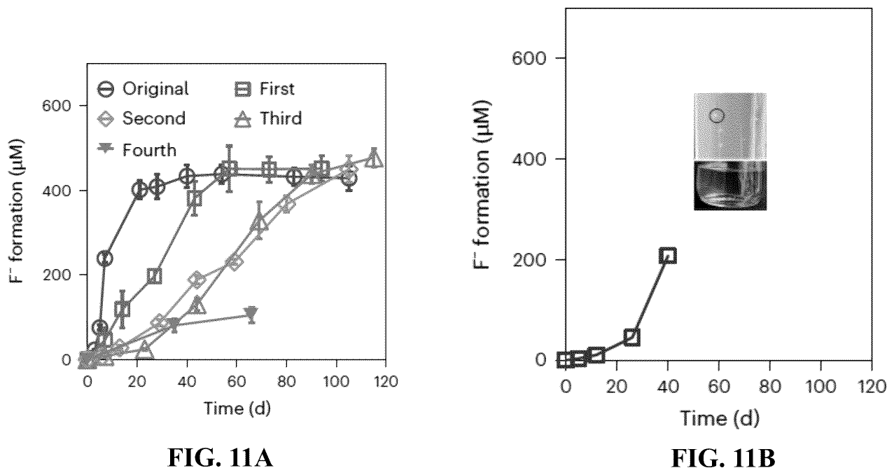

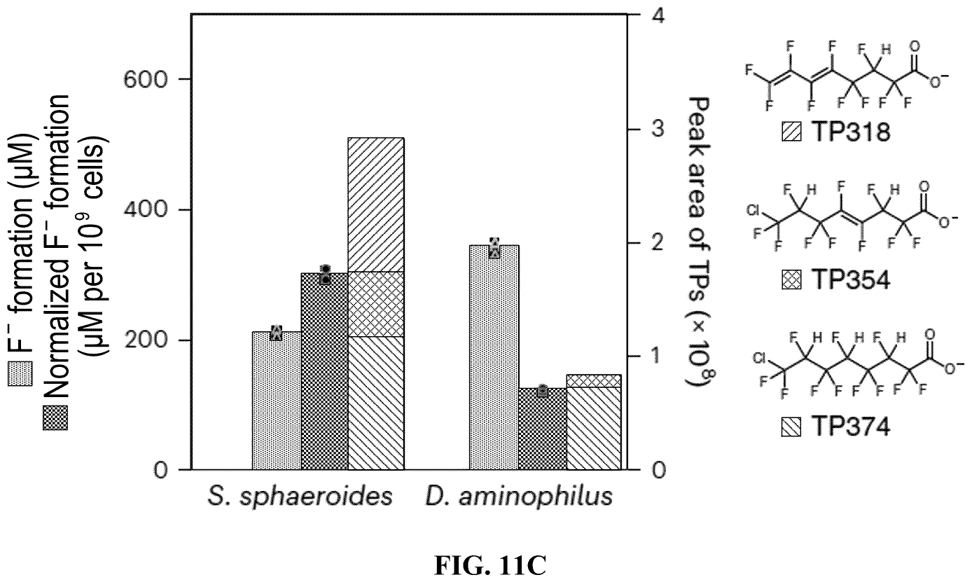

Three CTFE oligomer carboxylic acids investigated in this study, CTFE2, CTFE3, and CTFE4, as shown in FIG. 1A, were completely biotransformied with substantial fluoride release by the sludge community under anaerobic conditions. With increasing Cl substitutions in the structure from dimer to tetramer acid, the half-life decreased from nineteen days to three days, as shown in Tables 3, and the degree of defluorination increased significantly from less than 1000 to approximately 80% after 84 days, as shown in FIG. 11B. Aerobic biotransformation nor abiotic transformation were not noted in the anaerobic microbial dechlorination shown in FIG. 1A, except for a minor release of fluoride from CTFE4 in the heat-inactivated sludge controls (FIGS. 22J-22L). This was likely due to some remaining bioactivity in the controls.

TABLE 3
Parent compound decay half-lives, with 95% confidence
bounds, of twelve transformable PFAS calculated with
pseudo first-order reaction models by MATLAB.

| PFAS | Half-Life (Days) | R² |
|---|---|---|
| Cl-C2b | 11.5 ± 1.6 | 0.975 |
| Cl-C2c | 24.5 ± 3.4 | 0.937 |
| MFA | 73.2 ± 11.4 | 0.912 |
| Cl-C3b | 15.5 ± 2.3 | 0.972 |
| Cl-C3c | 5.0 ± 1.1 | 0.973 |
| C3c | N/A^{a} | N/A |
| Cl-C5a | N/A | N/A |
| Cl-C7a | N/A | N/A |
| Cl-C7a | 53.0 ± 15.5 | 0.772 |
| CTFE2 | 18.2 ± 8.5 | 0.870 |
| CTFE3 | 3.4 ± 0.4 | 0.995 |
| CTFE4 | 3.5 ± 3.0 | 0.882 |

^{a}N/A: the half-life is not applicable due to the slow biotransformation with less than 30% removal over observed time period.

Transformation product (TP) analysis indicated that the three CTFE oligomer acids first underwent microbial dechlorination reactions, including reductive, hydrolytic, and eliminative dechlorination. The hydrolytic dechlorination reaction triggered substantial defluorination, as shown in FIG. 1A, which was more favorable for the trimer and tetramer acids that have more Cl substitutions, leading to more defluorination. Reductive dechlorination gave TP's that were more recalcitrant to biotransformation and did not undergo defluorination. Eliminative dechlorination led to the formation of unsaturated TP's, some of which underwent much slower reductive defluorination or hydrogenation, contributing to the release of about zero to two fluorine ions. Stable unsaturated TP's with multiple carbon-carbon double bonds caused the dark-yellow color that developed during the defluorination of CTFE4.

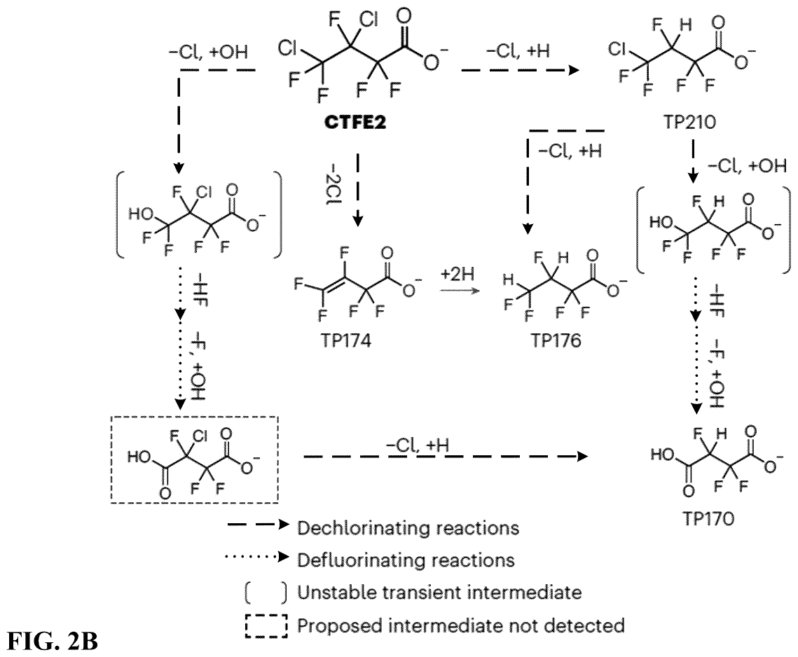

The hydrolytic dechlorination reaction produced unstable fluoro-alcohol moieties that underwent spontaneous HF elimination, as shown in FIG. 2A. The acyl fluoride structure resulting from the hydrolytic dechlorination at the terminal position could be further hydrolyzed, resulting in a diacid, such as TP170 in the case of the CTFE dimer acid CTFE2 as shown in FIG. 2B. The proposed TPs not detected by liquid chromatography coupled high-resolution mass spectrometry (LC-HRMS) are shown in dashed boxes in FIG. 2B. Two fluorine atoms were cleaved per molecule of TP170 formed in this defluorination pathway. The theoretical release of fluorine ions, approximately 15.8 μM, corresponding to approximately 7.9 μM TP170 formed on day 192 (FIG. 2B), was less than the actual total release of fluorine ions from CTFE2, approximately 26 μM. This may have been due to the formation of undetected defluorination intermediates such as chlorotrifluorosuccinic acid, as shown as shown in FIG. 2B. Assuming that two fluorine ions would be released per parent compound molecule via the defluorination pathways, the actual total release of 26 μM of fluorine ions would correspond to 13 μM of the initial approximately 52 μM CTFE2, as shown in FIG. 2B. Thus, the remaining approximately 39 μM of CTFE2 (about 75%) underwent non-defluorinating pathways, that is, reductive and eliminative dechlorination to form more recalcitrant TP's that exhibited slower or no biotransformation/defluorination, as shown in FIGS. 2A and 2B.

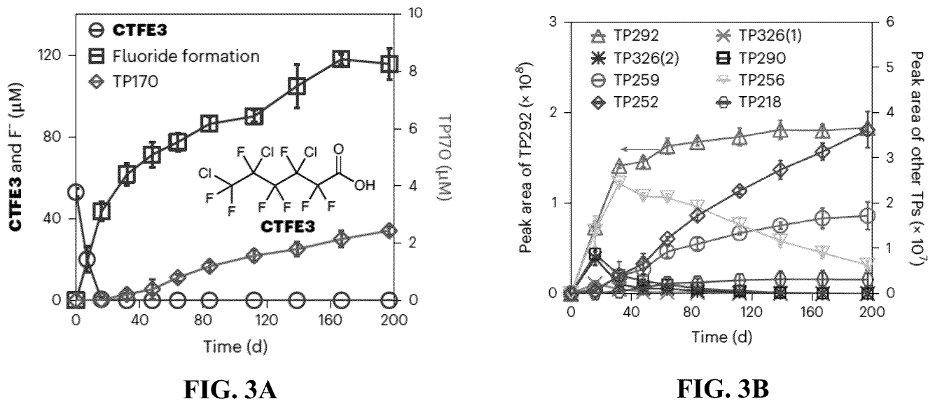

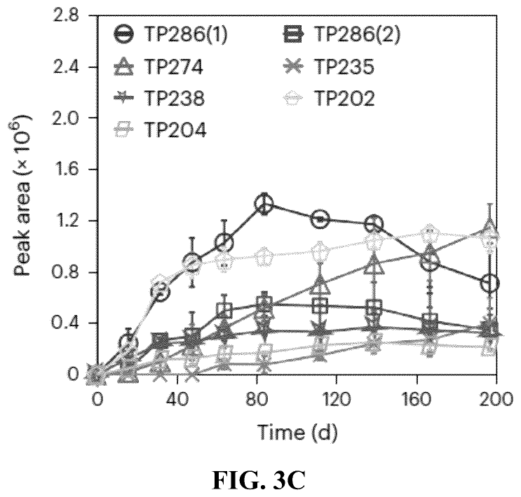

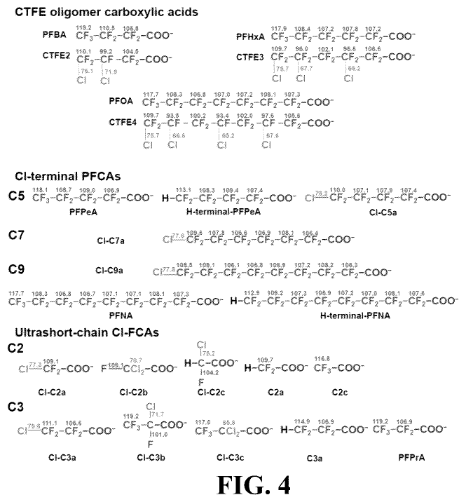

The biotransformation became faster with an increasing number of CTFE monomers in the oligomers. All three types of dechlorination reaction also occurred with the trimer and tetramer acids, CTFE3 and CTFE4 respectively, as indicated by the detected TP's, with the anaerobic hydrolytic dechlorination and spontaneous defluorination pathway more favored as more diacid TP's were formed, as shown in FIGS. 3A, 3B, and 3C. Theoretical bond dissociation energy (BDE) calculations, as shown in FIG. 4, suggested that the CDEs of the C—Cl bonds in CTFE3 and CTFE4 are lower than those in CTFE2, especially the internal C—Cl bonds. The C—Cl bonds with lower BDEs in CTFE3 and CTFE4 could become more reactive in an anaerobic microbial system, particularly in the hydrolytic dechlorination reaction, thus leading to faster biotransformation and greater defluorination.

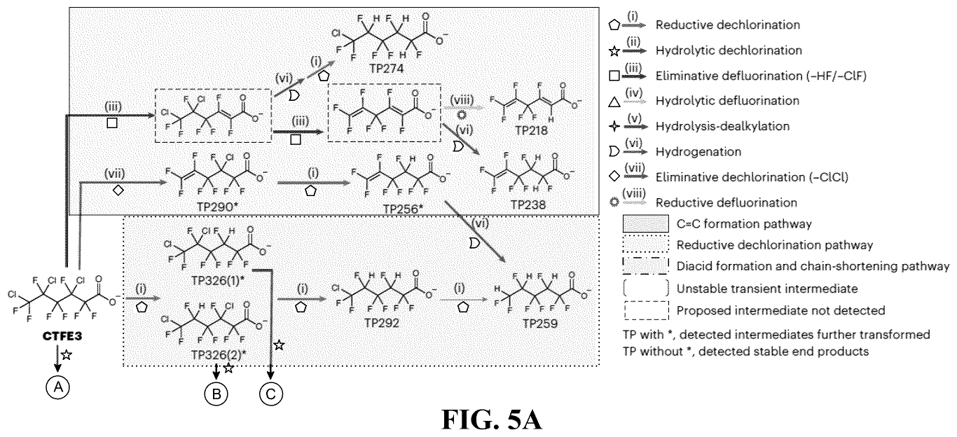

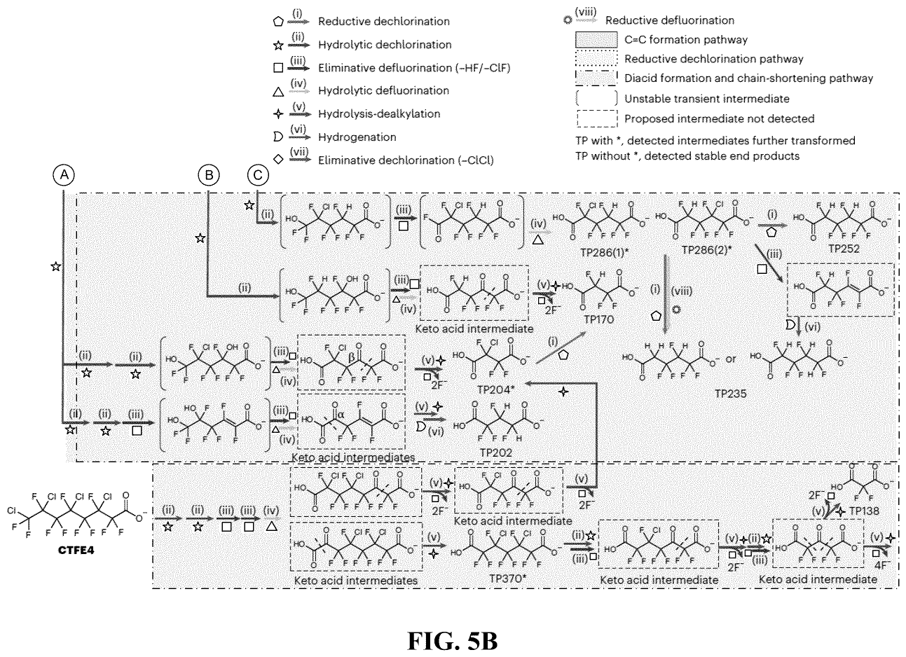

Besides diacid TP's with the same chain length as the starting CTFE, shorter-chain diacids were also formed in the hydrolytic dechlorination pathway, including C₄ and C₅ diacids from CTFE3 and C₃, C₄ and C₇ diacids from CTFE4, as shown in FIGS. 3A, 3B, 3C, and 5. The longer chain with additional Cl substitution in CTFE3 and CTFE4 likely allows hydrolytic dechlorination to occur at multiple Cl substitution sites in the middle of the structure either simultaneously or in series. Fluro keto acids (RCO(CH₂)ₙCOOH, n=0, 1, 2) may also be formed, as a fluoro keto acid was detected as a transient intermediate from CTFE4. The fluoro keto acids, if formed, would be unstable and undergo chain-shortening reactions to yield the detected shorter-chain acids or diacids, such as reaction v in FIGS. 5A and 5B. α-Keto diacids were decarboxylated, forming one-carbon-shortened TP's, as evidenced by the generation of TP202 from CTFE3 and TP370 from CTFE4 as shown in FIGS. 5A and 5B. The C₇ diacid TP370 was a major intermediate of CTFE4, and was further transformed, likely through hydrolytic dechlorination at either of the two Cl substitutions, forming C₇ β-keto fluoro diacids. C₆ and C₈ β-keto fluoro diacid intermediates were also proposed to form from CTEF3 and CTFE4 respectively as shown in FIGS. 5A and 5B. These structures are unstable and subject to hydrolysis. Furthermore, the microbial decomposition of β-keto acids to form acetate and the corresponding Cₙ₋₂ acid has been reported. However, difluoroacetate was not detected in the analysis indicating that it was not formed from the chain-shortening reaction as it is recalcitrant to anaerobic defluorination and would have accumulated and been detected if formed. Two alternative solutions were proposed: a carbene (:CF₂COO⁻) formed during C—C cleavage, followed by the formation of CO with fluorine ion release, similar to the transformation of CFCl₃ in the anaerobic iron porphyrin-cysteine system, or a hydroxy group attached to the leaving group, followed by spontaneous defluorination. C₅ and C₆ diacids from the deacetylation of the C₇ and C₈ β-keto fluoro diacids were not detected, indicating that further transformation was likely through hydrolytic dechlorination at the remaining Cl substitution sites, forming C₅ and C₆ β-keto diacids intermediates in FIGS. 5A and 5B. The C₅ β-keto diacid in FIGS. 5A and 5B could then be cleaved at two symmetric positions, leading to complete defluorination, or at one position to form stable difluoromalonic acid, a TP unique to CTFE4. The C₆ β-keto diacid may form a C₄ diacid, chlorosuccinic acid (TP204), which was also a deacetylation product from CTFE3 as shown in FIGS. 5A and 5B. Chlorotrifluorosuccinic acid, TP204, underwent a slow biotransformation to trifluorosuccinic acid, TP170, via reductive dechlorination as shown in in FIGS. 3A, 3B, 3C, and 5, suggesting that hydrolytic dechlorination is more difficult for C—Cl bonds in C₃ and C₄ fluoro diacids.

The major pathways leading to defluorination in the biotransformations of CTFE3 and CTFE4 were then identified. For the quantifiable less fluorinated TP's, trifluorosuccinic acid (TP170) and difluoromalonic acid (TP138) accounted for less than 10% (1.5-3 μM formation each) of the initial parent compound, indicating that they were not the major end products and that their formation pathways were not the major routes. Instead, for CTFE3, the formation of C₆ diacids (for example, TP252) with the release of two fluorine ions via the hydrolytic dechlorination pathway was more likely the major defluorination route. The greater defluorination (release of three to five fluorine ions) from chain-shortening pathways and the lower defluorination (release of zero or one fluorine ions) from the reductive and eliminative dechlorination pathways averaged out to 27% of the observed defluorination of CTFE3 (release of about two to eight fluorine atoms per molecule) on the last day of incubation, day 197. Similarly, according to the 77% total defluorination of CTFE4 after approximately 200 days, an average of eight to nine of the eleven fluorine atoms should be released per added CTFE4 if all underwent defluorination. As CTFE4 partially underwent reductive and eliminative dechlorination pathways with no or much lower fluorine ion release, it was expected that substantial portions of CTFE4 underwent complete defluorination through the pathway shown in FIGS. 5A and 5B, forming the C₇ diacid TP370.

### Dechlorination-Enhanced Defluorination of Other Polyfluorocarboxylic Acids

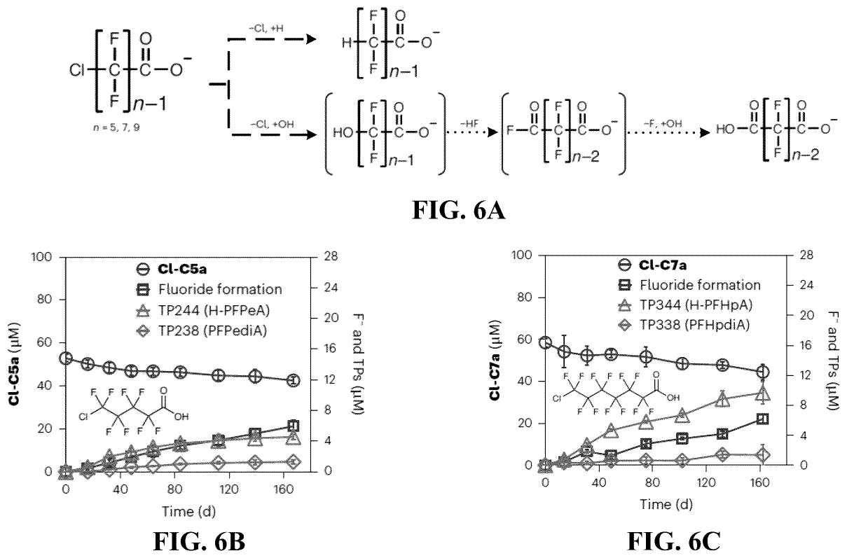

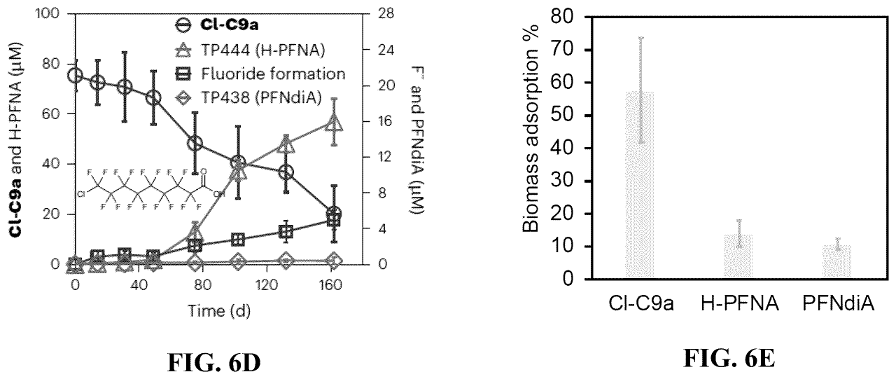

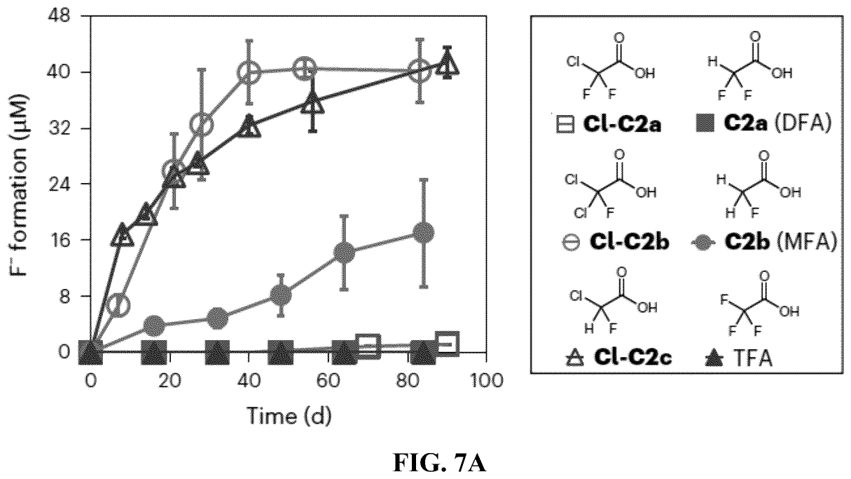

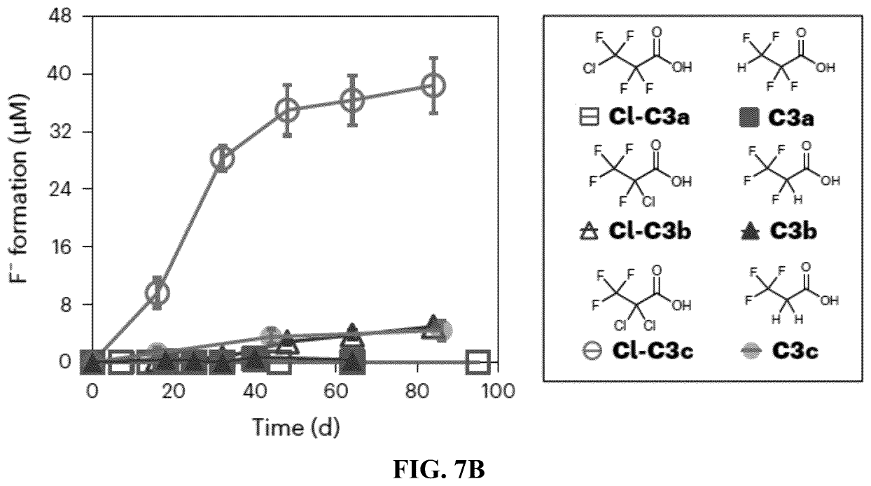

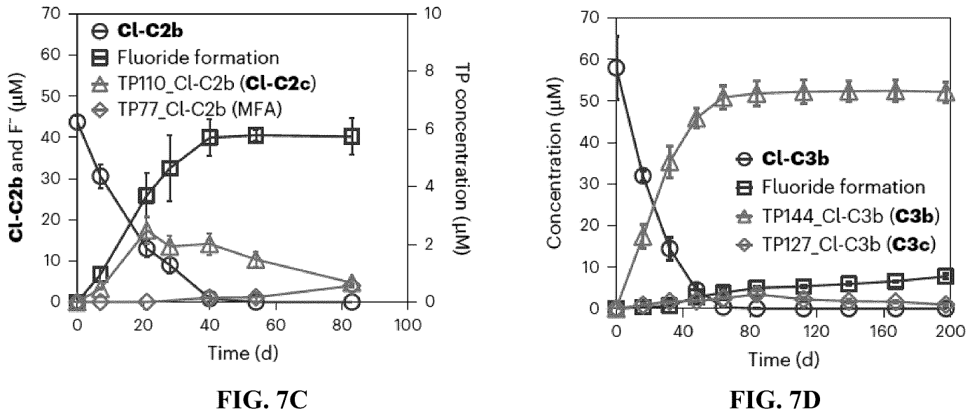

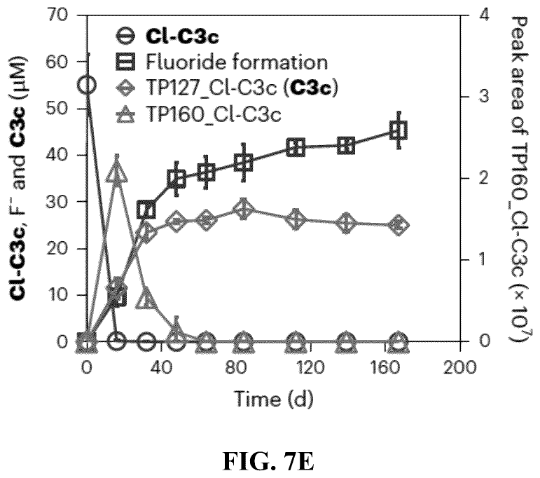

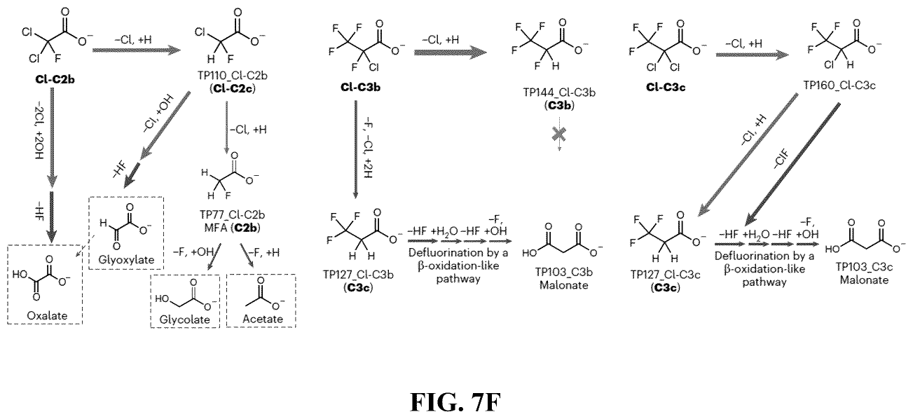

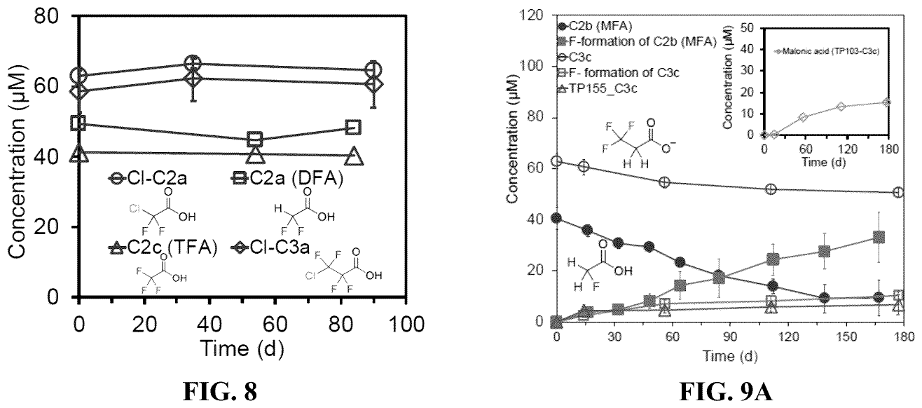

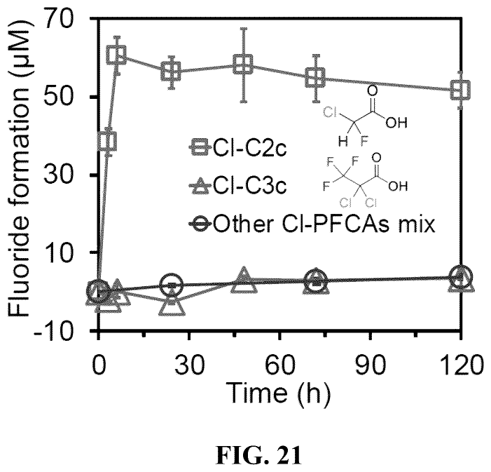

The biotransformation of other environmentally relevant Cl-polyfluorocarboxylic acids (PFCA), such as Cl-terminal and ultra-short-chain structures, was also significantly stimulated compared with H-substituted counterparts, which exhibited little to no biotransformation, as shown in FIGS. 6A-6E, 7A-7F, 8, 8A, 8B, 10A, 10B, and 21. The enhanced biodegradability was attributed to biodechlorination pathways similar to those of the CTFE oligomer acids. In contrast to the polychlorinated structures, CTFE oligomer acids and dichlorofluoro C₂ and C₃ acids, which showed fast and complete biotransformation and defluorination (FIGS. 1A, 1B, and 7A-7F), the biotransformations of monochlorinated structures, Cl-terminal polyfluorocarboxylic acids and monochloro-perfluoro C₂ and C₃ acids, was much slower as shown in Table 3. The biotransformation was incomplete after more than 160 days for the Cl-terminal C₅, C₇, and C₉ PFCAs, as shown in FIGS. 6A-6E, and the Cl-terminal C₂ and C₃ PFCAs did not show any biotransformation. This is in line with the much higher BDE of the terminal C—Cl bond in those structures as shown in FIG. 4.

All three biotransformed Cl-terminal PFCAs (C₅, C₇, and C₉) share two common biotransformation pathways, namely the major non-defluorinating reductive dechlorination pathway and the minor defluorinating hydrolytic dechlorination pathway, the was as for the CTFE oligomer acids (FIG. 6A). The reductive dechlorination of the parent compound increased with chain length as shown in FIGS. 6B-6D. More than half of Cl-C9a was reductively dechlorinated, while less than 25% of the C₅ and C₇ structures underwent the same process. Reductive dechlorination has been reported as the major biotransformation pathway for other Cl-terminal PFAS structures, such as 8:2 chlorinated polyfluorinated ether sulfonate (Cl-PFESA) and 6:2 Cl-PFESA (F-53B), which were not defluorinated. Notable active biosorption, about 60%, was observed for Cl-9a (n=9), while the tested structures with chain lengths of n less than or equal to eight showed less than 5% adsorption to biomass. Cl-9a was only taken up by actively growing biomass (FIG. 6E), and not by heat inactivated biomass (FIG. 22I). The active biosorption of its two TP's, H-terminal perfluorononanoic acid (H-PFNA) and perfluorononanoic diacid (PFNdiA) was much lower, about 10% to 13%, suggesting that the biotransformation of less mobile PFAS can result in TPs with higher mobility, thus being more easily transported into aqueous environments.

Compared with Cl-C3a with terminal Cl substitution, which did not exhibit any biotransformation, Cl-C3b (2-chloro-2,3,3,3-tetrafluoropropanoic acid) with α-Cl substitution showed a faster and more complete biotransformation, but without defluorination as shown in FIGS. 7A-7F. It was reductively dechlorinated to form the stable TP144 (2,3,3,3-tetrafluoropropanoic acid (C3b)) as shown in FIGS. 7A-7F. This agrees with the lower BDE of the α-C—Cl bond in Cl-C3b compared with the terminal C—Cl bond in Cl-C3a, which suggests that the C—Cl bonds closer to the carboxy group are more reactive as shown in FIG. 4.

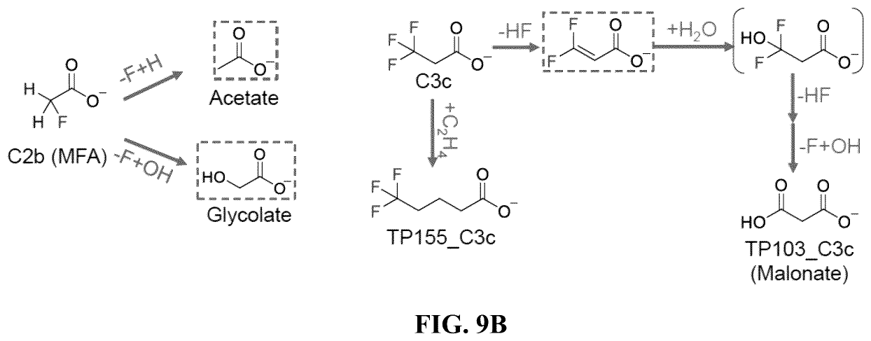

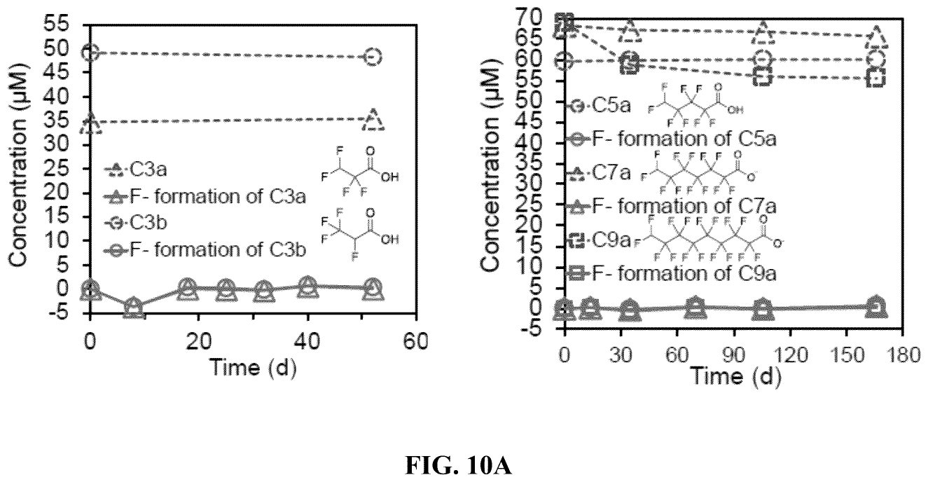

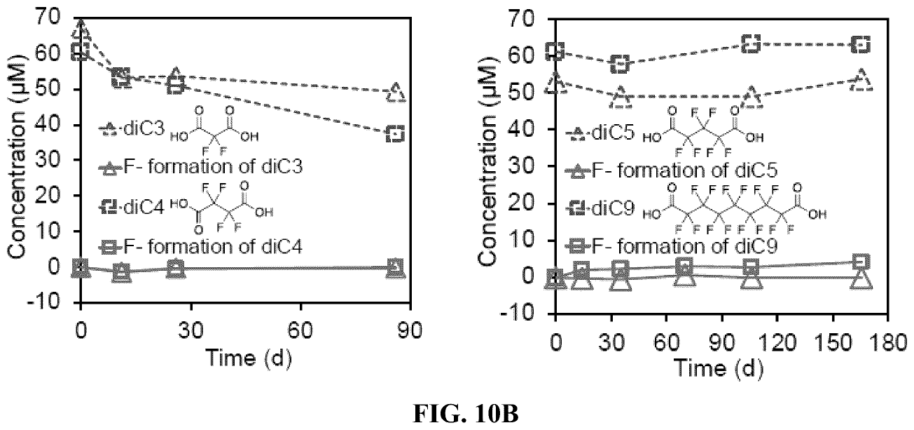

The reductive dechlorination product TP144 (C3b) accounted for 90% of the added Cl-C3b, with the formation of 3,3,3-trifluoropropionate (TP127, C3c) accounting for the remaining 10% (about 6 μM) as shown in FIGS. 7A-7F. C3c is the reductive dehalogenation product of Cl-C3b. As the chlorine to hydrogen reduction product C3b did not undergo further biotransformation, the fluorine to hydrogen exchange most likely occurred at the same time as the reductive dechlorination. The formation of C3c (approximately 2-3 μM after 64 days) resulted in an equal molar concentration of fluorine ion release as shown in FIG. 7A-7F. C3c was very slowly defluorinated anaerobically, leading to a further small increase in released fluorine ions after the depletion of Cl-C3b as shown in FIGS. 7A-7F. The anaerobic defluorination of C3c occurred through the same β-oxidation-like pathway as its aerobic defluorination. This conclusion is supported through the overall increase in malonate, the end product of this particular pathway as shown in FIGS. 9A and 9B. The reductive dechlorination of 2,2-dichloro-3,3,3-trifluoropropanoic acid (Cl-C3c) also led to the formation of C3c, but the slow defluorination of C3c could not contribute to the rapid release of fluorine ions from Cl-C3c observed with the first 40 days as shown in FIGS. 7A-7F. Instead, the primary reductive dechlorination product TP160 seemed to partially undergo eliminative dehalogenation (—ClF), leading to a 1:1 release of fluorine ions. The —ClF product, an intermediate of the C3c biodefluorination pathway, was not detected and might be further transformed. This pathway led to a slower release of fluorine ions after the depletion of TP160 as shown in FIG. 10A-F.

It is likely that the two C₂ acids 2,2-dichloro-2-fluoroacetate (Cl-C2b) and its primary reductive dechlorination product 2-chloro-2-fluoroacetate (Cl-C2c) underwent hydrolytic dechlorination, triggering the nearly complete defluorination as shown in FIG. 7A-7F. The reductive dechlorination product TP77 (2-fluoroacetic acid) of Cl-C2b and Cl-C2c was detected at low levels, and its defluorination was slow as shown in FIGS. 7A-7F and 9A-9B. Thus, the fast and complete defluorination should be triggered by the hydrolytic dechlorination of CL-C2b and Cl-C2c. In previous experiments, di- and monochloroacetate were converted into glyoxylate by haloacid dehalogenase in an anaerobic bacterium ‘Candidatus Dichloromethanomonas elyunquensis’ strain via hydrolytic dechlorination. Thus, it is possible that the structurally similar Cl-C2b and Cl-C2c, with one C—H bond replaced by a C—F bond, can also undergo hydrolytic dechlorination in an anaerobic microbial community, leading to spontaneous cleavage of the C—F bond.

### Microorganisms Responsible for Defluorination of CTFE4

CTFE4 experienced the greatest degree of defluorination during the biotransformation. To determine the microorganisms responsible for the defluorination of CTFE4, the biomass was enriched by enriching the subculture, transferring about 5% by volume of the previous culture into the same basal medium as before amended with 123 mM methanol and 50 μM CTFE4. During the enrichment process, the defluorination rate of CTFE4 decreased after four rounds of subculture enrichment as shown in FIG. 11A. This suggests that the dehalogenation of CTFE4 does not support or benefit the sustainable growth of the responsible microorganisms, rendering diluted biomass and decreasing defluorination activity. As CTFE4 dehalogenation did not lead to outgrowth of the responsible microorganisms, cultivation-independent metagenomic analysis would not provide clear clues to the identity of the responsible microorganisms, as the abundant species would most likely be those grown by methanol fermentation without CTFE4 dehalogenation.

The isolation approach was utilized to identify the responsible microbes. In the third subculture, one colony was isolated that exhibited similar CTFE4 defluorination activity as the third subculture in the same medium after 40 days as shown in FIG. 11B. The isolated culture was highly enriched, containing two dominant bingenomes that were most similar to the genomes of Desulfovibrio aminophilus and Sporomusa sphaeroides as shown in Tables 4 and 5, below.

TABLE 4
Bingenomes reconstructed from metagenomes of the isolated CTFE4-defluorinating colony

| | | | Relative | | Similarity |
|---|---|---|---|---|---|
| | Completeness | Contamination | Abundance | | (coverage) |
| Bingenome | (%) | (%) | (%) | Closest Genome | (%) |
| Bin 1 | 100 | 3.69 | 35.77 | Sporomusa sphaeroides | 97.3 (82) |
| Bin 2 | 100 | 0 | 48.98 | Desulfovibrio | 92.0 (82) |
| | | | | aminophilus | |
| Bin 3 | 88.57 | 3.49 | 2.1 | Unclassified | 89.8 (80) |
| | | | | Bacteroidales (o) | |
| Bin 5 | 99.45 | 0 | 3.25 | Unclassified | 93.0 (81) |
| | | | | Dysgonamodaceaes (f) | |

Note:
o: order;
f:family

TABLE 5
Primary characteristics of the two major genomes reconstructed
from the metagenome of the isolated colony.

| | | | | HAD family | Dissimilatory sulfate |
|---|---|---|---|---|---|
| Bingenome | Closest Genome | RDH | HAD | hydrolase | reduction pathway |
| Bin 1 | S. sphaeroides | 0 | 0 | 1 | 97.3 (82) |
| Bin 2 | D. aminophilus | 0 | 0 | 1 | 92.0 (82) |

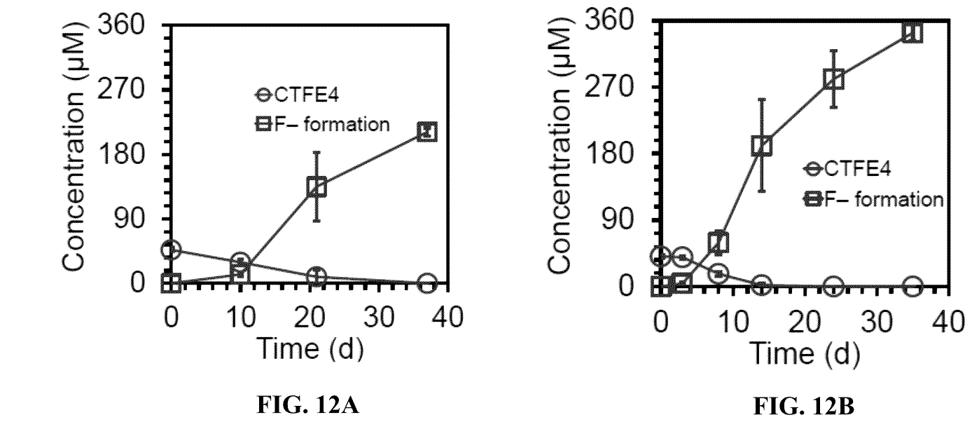

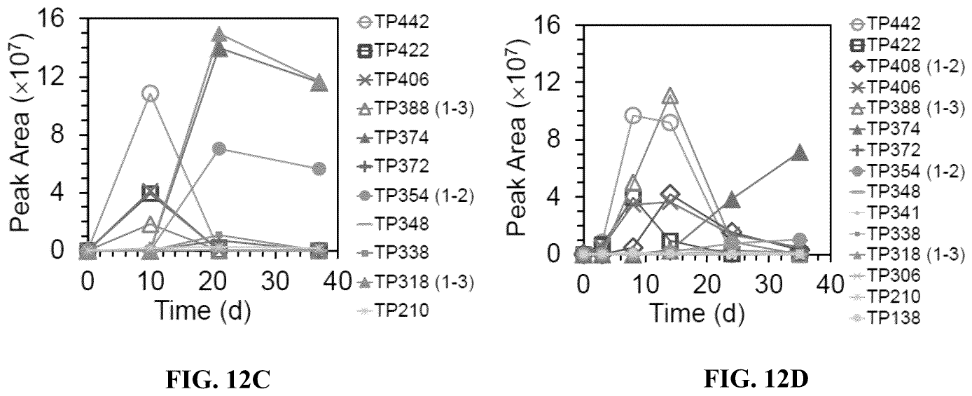

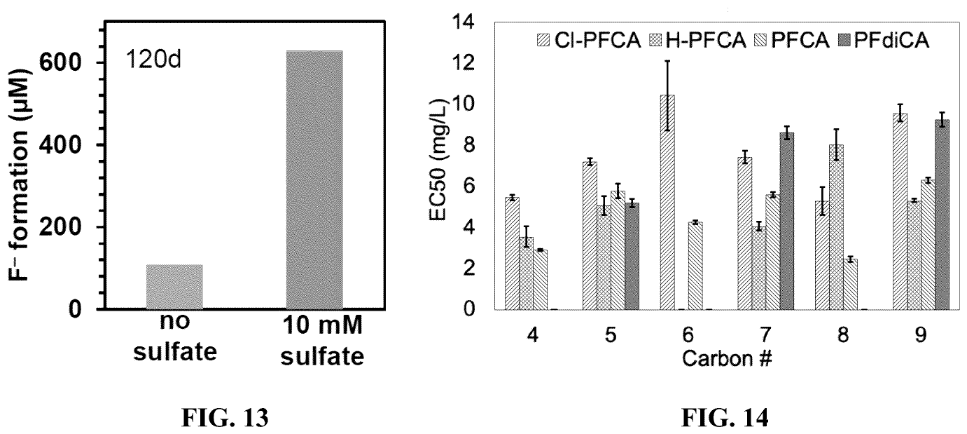

Pure cultures of Desulfovibrio aminophilus (DSM 12254) and Sporomusa sphaeroides (DSM 2875) were obtained, which completely degraded CTFE4 after 14 and 21 days respectively as shown in FIGS. 12A-12D. The total defluorination was about two-fold higher in D. aminophilus (about 77%) than in S. sphaeroides (about 41%) as shown in FIGS. 12A-12D. This faster removal and greater defluorination of CTFE4 through D. aminophilus can be attributed to its faster growth than S. sphaeroides, the latter of which showed a higher defluorination capacity per cell, about 2.4-fold greater. Additionally. S. sphaeroides converted more CTFE4 into stable, less defluorinated products through reductive and eliminative dechlorination, and this could also result in the lower total defluorination compared with D. aminophilus as shown in FIGS. 11A-11C. Given the phylogenetically insignificant similarity of the two identified genomes to the two tested pure strains, as well as the phylogenetic divergence between the two genomes, CTFE4-degrading microorganisms might be less specific across the same genus and commonly occurring in anaerobic environments. Knowing the characteristics of the defluorinating microorganisms could help to enhance defluorination in a microbial community. Given that the Desulfovibrio-like bingenome possesses dissimilatory sulfate reduction pathways, by providing sulfate to the fourth subculture of the CTFE4-defluorinating microcosm with declined defluorination activity, selective growth stimulation of the defluorinating sulfate reducers was achieved, substantially boosting the defluorination of CTFE4 as shown in FIGS. 10A-10B, 11A-11C, and 13. Neither of the two bingenomes has genes annotated as reductive halogenases as shown in FIGS. 11A-11C. Only one haloacid dehydrgogenase (HAD) family hydrolase gene with unclear specific function was annotated in the two bingenomes with 40% amino acid similarity. Whether the HAD family protein could catalyze the hydrolytic dechlorination of CTFE4 remains unclear.

### Implications for PFAS Degradation

Polytetrafluoroethylene (PTFE) and PCTFE are two widely used fluoropolymers. Compared with polytetrafluoroethylene, PCTFE, with one F substituted by Cl in the CTFE monomer, would become more biodegradable and less persistent in the environment once transformed into CTFE oligomer carboxylic acids via thermal decomposition or oxidative metabolism. It is also clear that longer-chain CTFE oligomer acids may have an even shorter half-life and undergo much greater defluorination in anaerobic environments where the responsible microorganisms, such as Desulfovibrio and Sporomusa are commonly distributed. Despite the enhanced bioavailability of the Cl-substituted structures, only specific types of dechlorination can trigger the defluorination of CTFE acids, hydrolytic and eliminative dechlorination. The previously underestimated non-respiratory hydrolytic dechlorination genes in chlorinated natural organic matter cycling may play a critical role in the defluorination of chlorinated PFAS.

While it is commonly believed that an increase in the number of Cl substitutions could render more toxic PFAS, this seems to not be true with regards to the microbial toxicity of chlorinated PFAS. The mono- and poly-Cl-PFCAs, the C₄ through C₉ variants, have shown a lower inhibitory effect than PFCAs with the same chain length on the luminescence of Vibrio fischeri, a standard measurement for acute toxicity, as shown in FIG. 14. FIG. 14 shows a comparison of microbial activity of Cl-PFCA, h_PFCA, PFCA, and PFdiCA (50 μM each dissolved in MilliQ water) on Vibrio fischeri. For the Cl-PFCAs in FIG. 14, C#'s 4, 6, and 8 represent CTFE2, CTFE3, and CTFE4 respectively, and C#'s 5, 7, and 9 represent Cl-terminal PFCA. In contrast, the H-terminal PFCA, a major biotransformation product of the corresponding Cl-terminal PFCA, exhibited a higher inhibitory effect on the luminescence than the parent compound. The luminescent bacteria test only indicated acute microbial toxicity, and toxicity tests using higher organisms are needed to obtain a comprehensive and systematic evaluation of the ecotoxicity of chlorinated PFAS.

Another concern may be that while Cl substitutions enhanced biodegradability, complete defluorination was still not achieved due to non-defluorinating biotransformation pathways such as the reductive dechlorination pathway. The incompletely defluorinated products may have greater mobility in aquatic conditions, leading to a greater toxicity in the ecosystem. Nonetheless, as many of these compounds contain C—H bonds at saturated or unsaturated carbon atoms, they are prone to aerobic degradation.

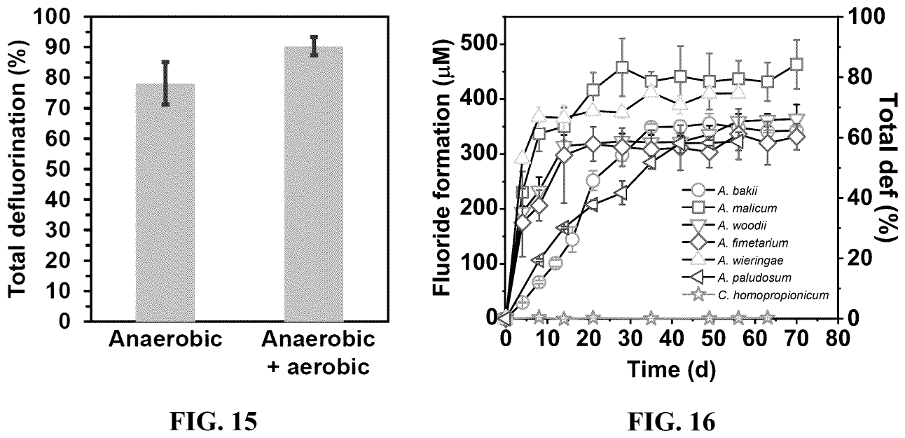

The spent medium of cultures was collected after reaching maximum anaerobic defluorination of the CTFE tetramer acid, about 80%, and further treated aerobically with an activated sludge community collected from the same wastewater treatment source. An additional 12% defluorination was detected over nine days, as shown in FIG. 15. Therefore, a sequential anaerobic-aerobic bioreactor could be adapted and employed to effectively treat wastewater containing CTFE tetramer acid by increasing the overall anaerobic sludge retention time.

The identified biotransformation pathways provide insight into PFAS source tracking, risk assessment, and environmental monitoring. Besides the reported H-terminal polyfluorocarboxylic acids from reductive dechlorination, perfluorodicarboxylic acids and unsaturated fluorocarboxylic acids were demonstrated herein from the anaerobic biotransformation of various Cl-PFCAs. Thus, Cl-PFCAs could be a critical source of all three of the above classes of emerging PFAS detected in different environments. Closer and more accurate PFAS monitoring and toxicity studies could also be conducted on the non- and slowly biotransformed Cl-PFAS as well as the stable products.

### Example 2: Testing of Additional Bacterial Species

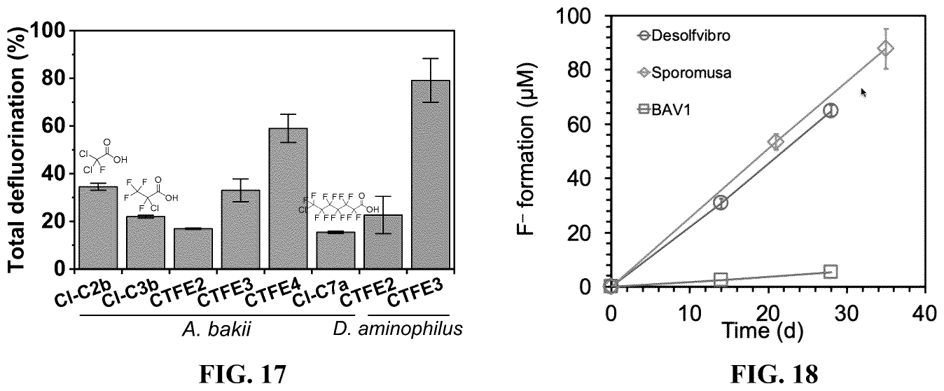

Additional bacterial species were found capable of defluorinating CTFE tetramer acid (CTFE4). Using the testing protocol found in Example 1 and the methods section, besides the above identified and tested bacterial species Desulfovibrio aminophilus and Sporomusa sphaeroides, six Acetobacterium species were found also able to biotransform and defluorinate CTFE oligomer acids. Another tested species, Clostridium homopropionicum, was not able to biotransform CTFE oligomer acids as shown in FIG. 16. Acetobacterium bakii was also able to defluorinate the other two CTFE oligomer acids (CTFE2 & CTFE3), and other chlorinated PFAS (Cl-PFAS), similar to D. aminophilus and S. sphaeroides as shown in FIG. 17.

### Example 3: Defluorination of CTFE Trimer by the CTFE4 Defluorinating Pure Cultures

Using the testing protocol found in Example 1 and the methods section, the two pure cultures capable of CTFE4 defluorination was found to directly defluorinate the alkane form of CTFE oligomers, such as CTFE trimer as shown in FIG. 18, with decreased defluorination activity, i.e., the total defluorination. FIG. 18 depicts the fluoride formation from the alkane form of 50 M CTFE trimer by D. aminophilus and S. sphaeroides, where BAV1 was the medium-only control. In this experiment, fluoride kept increasing, and did not reach the maximum defluorination after 30 days. This decreased activity was likely due to the lack of a carboxylic acid. The initial step may be using pre-treatment to convert the terminal C—Cl bond into a carboxylic group via abiotic or biological oxidation process.

### Example 4: Significant Defluorination of CTFE4 by the Spent Medium of D. aminophilus

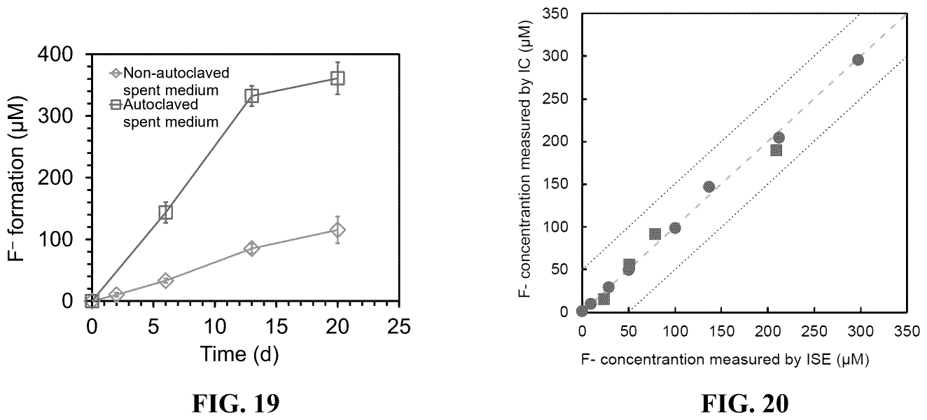

Using the testing protocol found in Example 1 and the methods section, the defluorination of CTFE4 occurred extracellularly as the spent medium also showed defluorination activity as shown in FIG. 22. This process must be microbially mediated because the fresh medium without biomass did not show any defluorination activity. Moreover, when the spent medium was treated by heat through autoclavation, it exhibited even much higher defluorination activity as shown in FIG. 19. This result suggested that some heat-resistant co-factors or enzymes produced during the growth of the pure culture were responsible for the defluorination.

### Example 5: Efficient Defluorination of CTFE4 by Heme B in the Presence of Sulfide

Heme b is a biomolecule commonly produced and used in microbial cells. The degradation and defluorination of CTFE4 by heme b in BAV1, a basal medium containing mineral salts, plus the reducing agent containing 0.2 mM L-cysteine and 0.2 mM sodium sulfide in anaerobic conditions was assessed and compared to controls of BAV1 alone, iron sulfide (Fe₂S) in BAV1, and BAV1 and heme b in aerobic conditions. As show in FIG. 32A, heme b in BAV1 and anaerobic conditions exhibited effective degradation and defluorination (36% total defluorination within 12 days) of CTFE4. By comparison, the no degradation and defluorinated was exhibited in BAV1 alone, iron sulfide in BAV1 and heme b in BAV1 in aerobic conditions.

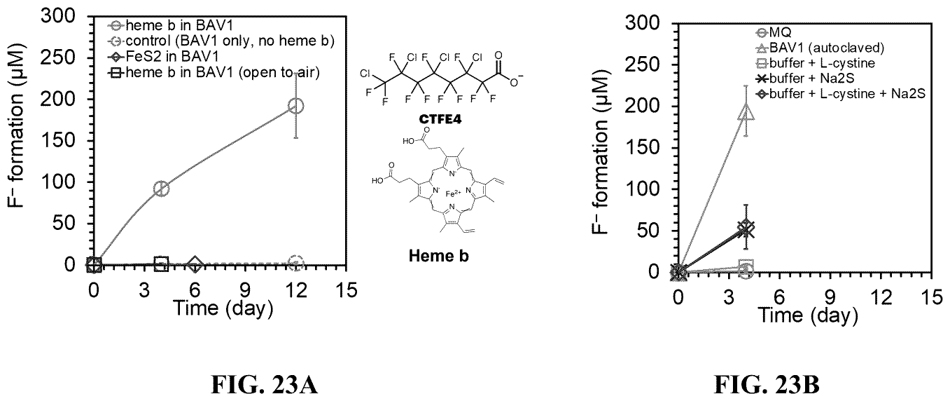

Additionally, analysis of heme b in other media absent of sodium sulfide (i.e., milliQ water, autoclaved BAV1 medium containing 2 M heme b, 10 mM NaHCO₃ buffer solution+0.2 mM cysteine, 10 mM NaHCO₃ buffer solution+0.2 mM sodium sulfide, and 10 mM NaHCO₃ buffer solution+both L-cysteine and sulfide) showed that the defluorination of CTFE4 required both heme b and sulfide (FIG. 23B). Specifically, no activity was observed in a matrix containing heme b only or heme b with L-cysteine (serving as a reducing agent to quench dissolved oxygen and maintain the anaerobic condition). On the other hand, autoclaved BAV1 medium (with the addition of L-cysteine and sodium sulfide and heme b) enhanced the defluorination rate by about 3-fold, achieving ˜36% total defluorination within 5 days (FIG. 23B).

### Example 6: High Degradation of CTFE Oligomer was Achieved by Chemical Oxidation Plus Anaerobic Microbial Degradation

CTFE oligomers differ from CTFE oligomer acid by lacking the carboxyl group, which makes CTFE oligomers less biodegradable. To degrade CTFE oligomer, the oligomer must first be converted to its acid form, which will be readily biodegradable. In an attempt to achieve biodegradation of CTFE oligomers, advanced oxidation process (AOP) using heated persulfate was tested using CTFE pentamer as a representative CTFE oligomer. Although AOP by heated persulfate itself did not lead to significant downstream biological degradation of CTFE pentamer, addition of 0.25% tween 60 (a surfactant) in the AOP solution (10 mM persulfate, pH 12, heated by autoclavation) significantly enhanced the defluorination in the downstream microbial degradation step by activated sludge in anaerobic conditions. Defluorination of CTFE pentamer was assessed with various AOP treatment methods including tween 60, as follows:
A—AOP with 0.25% tween 60, 10 mM persulfate, at pH 12 for 1 hour, anaerobic sludge treatment after adjusting pH back to 7;
B—AOP with 0.25% tween 60, 10 mM persulfate, at pH 12 for 1 hour;
C—anaerobic sludge treatment only for 60 days;
D—0.25% tween 60 in BAV1 medium with 0.2 mM L-cysteine and 0.2 mM sodium sulfide under anaerobic incubation for 60 days.

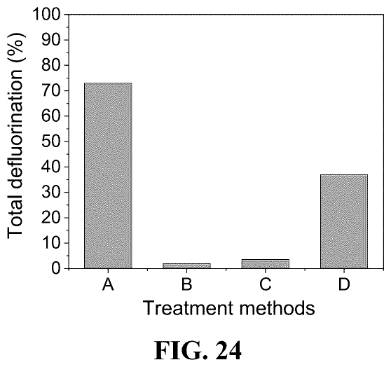

As shown in FIG. 24, a total of 73% defluorination of 50 μM CTFE pentamer (i.e., 73% CTFE pentamer was mineralized) was achieved after 35 days by the surfactant facilitated AOP+microbial degradation method (A), compared to 2% after 1 h AOP, 3.6% for the anaerobic biodegradation only after 60 days, and 37% for the anaerobic treatment of tween 60 only after 60 days.

Various embodiments of the present technology are set forth herein below in paragraphs [0154]-[0194]:

Embodiment 1. A method of biodegrading chlorotrifluoroethylene (CTFE) oligomers, oligomer acids, and derivatives thereof, the method comprising:
inoculating one or more bacteria into a growth substrate, wherein the one or more bacteria is selected from the group consisting of Acetobacterium bakii, Acetobacterium malicum, Acetobacterium woodii, Acetobacterium fimetarium, Acetobacterium wieringae, Acetobacterium paludosum, Desulfovibrio aminophilus, and Sporomusa sphaeroides;
adding the inoculated growth substrate into a biomass inside a first biological treatment unit, wherein the first biological treatment unit is kept under anaerobic conditions;
depositing wastewater into the first biological treatment unit;
retaining the wastewater in the first biological treatment unit for a first time period;
adding the inoculated growth substrate into a biomass inside a second biological treatment unit, wherein the second biological treatment unit is kept under aerobic conditions;
transferring the wastewater from the first biological treatment unit to the second biological treatment unit;
retaining the wastewater in the second biological treatment unit for a second time period; and
testing the wastewater to determine the concentration of chemical compounds selected from the group consisting of CTFE oligomers, oligomer acids, and derivatives thereof, and/or breakdown products from the biological degradation of CTFE oligomers, oligomer acids, and derivatives thereof.

Embodiment 2. The method of embodiment 1, wherein the one or more bacteria is one or more of Desulfovibrio spp., Acetobacterium spp., and Sporomusa spp.

Embodiment 3. The method of embodiment 1, wherein the growth substrate is selected from the group consisting of lactate and fructose.

Embodiment 4. The method of embodiment 1, wherein the growth substrate further comprises sulfate and organic carbon.

Embodiment 5. The method of embodiment 1, wherein the growth substrate further comprises a compound selected from the group consisting of acetate and methanol.

Embodiment 6. The method of embodiment 1, wherein the biomass contains an activated sludge bacterial community.

Embodiment 7. The method of embodiment 1, wherein the one or more bacteria are combined with an activated sludge bacterial community taken from a wastewater treatment plant.

Embodiment 8. The method of embodiment 1, wherein the first time period is between about 30 days to about 45 days.

Embodiment 9. The method of embodiment 1, wherein the second time period is between about 10 days to about 20 days.

Embodiment 10. The method of embodiment 1, wherein the second time period is between about 5 days to about 15 days.

Embodiment 11. The method of embodiment 1, wherein the target biodegradation percentage of CTFE oligomers, oligomer acids, and derivatives thereof, in the wastewater after exiting the first biological treatment unit ranges from about 70% to about 95%.

Embodiment 12. The method of embodiment 11, wherein the target biodegradation percentage of CTFE oligomers, oligomer acids, and derivatives thereof in the wastewater after exiting the first biological treatment unit ranges from about 80% to about 90%.

Embodiment 13. The method of embodiment 1, wherein the target biodegradation percentage of CTFE oligomers, oligomer acids, and derivatives thereof, in the wastewater after exiting the second biological treatment unit ranges from about 5% to about 20%.

Embodiment 14. The method of embodiment 13, wherein the target biodegradation percentage of CTFE oligomers, oligomer acids, and derivatives thereof, in the wastewater after exiting the second biological treatment unit ranges from about 5% to about 10%.

Embodiment 15. The method of embodiment 1, wherein the first biological treatment unit is inoculated with a cell culture containing the one or more bacteria.

Embodiment 16. The method of embodiment 15, wherein the first biological treatment unit is inoculated with an autoclaved spent media of the cell culture containing the one or more bacteria.

Embodiment 17. The method of embodiment 1, wherein the first biological treatment unit is inoculated with a cell culture containing the one or more bacteria and an autoclaved spent media of the cell culture containing the one or more bacteria.

Embodiment 18. The method of embodiment 1, wherein the second biological treatment unit is inoculated with an activated sludge community taken from a wastewater treatment plant.

Embodiment 19. The method of embodiment 1, wherein the first biological treatment unit and the second biological treatment unit are connected in series.

Embodiment 20. The method of embodiment 1, wherein the first biological treatment unit and the second biological treatment unit are integrated into one unit.

Embodiment 21. The method of embodiment 1, wherein the first biological treatment unit and/or the second biological treatment unit are connected to an incineration tower.

Embodiment 22. The method of embodiment 1, wherein the first biological treatment unit and/or the second biological treatment unit are linked to a wastewater outlet flow from a commercial or industrial site.

Embodiment 23. The method of embodiment 1, wherein the first biological treatment unit and/or the second biological treatment unit are linked to a wastewater flow.

Embodiment 24. The method of embodiment 1, wherein the first biological treatment unit and/or the second biological treatment unit contain a chemical monitoring system.

Embodiment 25. The method of embodiment 1, wherein the wastewater contained within the first biological treatment unit or the second biological treatment unit are tested for residual CTFE oligomers, oligomer acids, derivatives thereof, and degradation byproducts through automated sample removal and/or sample testing.

Embodiment 26. The method of embodiment 1, wherein the wastewater contained within the first biological treatment unit or the second biological treatment unit are tested for residual CTFE oligomers, oligomer acids, derivatives thereof, and degradation byproducts through manual sample removal and/or sample testing.

Embodiment 27. A method of biodegrading a chlorotrifluoroethylene (CTFE) oligomer acid, the method comprising:
combining the CTFE oligomer acid with heme b in a medium comprising sodium sulfide under anaerobic conditions; and
maintaining the combination at anaerobic conditions for a period of time sufficient to achieve defluorination of the CTFE oligomer acid.

Embodiment 28. The method of embodiment 27, wherein the medium comprising sodium sulfide is BAV1.

Embodiment 29. The method of embodiment 28, wherein combining the CTFE oligomer acid with heme b in a medium comprising sodium sulfide under anaerobic conditions comprises:
adding the heme b to the BAV1;
autoclaving the BAV1 containing the heme b; and
adding the CTFE oligomer acid to the BAV1 after autoclaving the BAV1 containing the heme b.

Embodiment 30. The method of embodiment 27, wherein the period of time is five days.

Embodiment 31. The method of embodiment 30, wherein the method achieves at least 30% defluorination of the CTFE oligomer acid.

Embodiment 32. A method of biodegrading chlorotrifluoroethylene (CTFE) oligomers, the method comprising:
treating the CTFE oligomer using an advanced oxidation process (AOP) to produce an AOP treatment product;
adding the AOP treatment product into a biomass inside a biological treatment unit maintained under anaerobic conditions;
depositing wastewater into the biological treatment unit;
retaining the wastewater in the biological treatment unit for a time period; and
testing the wastewater to determine the concentration of the CTFE oligomer and/or breakdown products from the biological degradation of the CTFE oligomer.

Embodiment 33. The method of embodiment 32, wherein the advanced oxidation process comprises:
combining the CTFE oligomer with a surfactant in persulfate; and
heating the combination at basic pH for one to four hours.

Embodiment 34. The method of embodiment 33, wherein the surfactant is polysorbate 60.

Embodiment 35. The method of embodiment 33, wherein heating the combination comprises autoclaving the combination.

Embodiment 36. The method of embodiment 33, wherein the combination is heated at a pH of 12.

Embodiment 37. The method of embodiment 33, wherein the combination is heated for one hours.

Embodiment 38. The method of embodiment 32, wherein the biomass contains an activated sludge bacterial community.

Embodiment 39. The method of embodiment 32, wherein the time period is 35 days.

Embodiment 40. The method of embodiment 32, wherein the method achieves at least 70% defluorination of the CTFE oligomer acid.

Embodiment 41. An apparatus configured to implement a method recited in any of embodiments 1 to 40.

While this specification contains many specifics, these should not be construed as limitations on the scope of an invention or of what may be claimed, but rather as descriptions of features specific to particular embodiments of the invention. Certain features that are described in this specification in the context of separate embodiments can also be implemented in combination in a single embodiment. Conversely, various features that are described in the context of a single embodiment can also be implemented in multiple embodiments separately or in any suitable sub-combination. Moreover, although features may be described above as acting in certain combinations and even initially claimed as such, one or more features from a claimed combination can in some cases be excised from the combination, and the claimed combination may be directed to a sub-combination or a variation of a sub-combination.

Only a few implementations are disclosed. However, variations and enhancements of the disclosed implementations and other implementations can be made based on what is described and illustrated in this specification.

From the foregoing, it will be appreciated that specific embodiments of the invention have been described herein for purposes of illustration, but that various modifications may be made without deviating from the scope of the invention. Accordingly, the invention is not limited except as by the appended claims.

We claim:

1. A method of biodegrading chlorotrifluoroethylene (CTFE) oligomers, oligomer acids, and derivatives thereof, the method comprising:
inoculating one or more bacteria into a growth substrate, wherein the one or more bacteria is selected from the group consisting of Acetobacterium bakii, Acetobacterium malicum, Acetobacterium woodii, Acetobacterium fimetarium, Acetobacterium wieringae, Acetobacterium paludosum, Desulfovibrio aminophilus, and Sporomusa sphaeroides;
adding the inoculated growth substrate into a biomass inside a first biological treatment unit, wherein the first biological treatment unit is kept under anaerobic conditions;
depositing wastewater into the first biological treatment unit;
retaining the wastewater in the first biological treatment unit for a first time period;
adding the inoculated growth substrate into a biomass inside a second biological treatment unit, wherein the second biological treatment unit is kept under aerobic conditions;
transferring the wastewater from the first biological treatment unit to the second biological treatment unit;
retaining the wastewater in the second biological treatment unit for a second time period; and
testing the wastewater to determine the concentration of chemical compounds selected from the group consisting of CTFE oligomers, oligomer acids, and derivatives thereof, and/or breakdown products from the biological degradation of CTFE oligomers, oligomer acids, and derivatives thereof.

2. The method of claim 1, wherein the one or more bacteria is one or more of Desulfovibrio spp., Acetobacterium spp., and Sporomusa spp.

3. The method of claim 1, wherein the growth substrate is selected from the group consisting of lactate and fructose.

4. The method of claim 1, wherein the growth substrate further comprises sulfate and organic carbon and/or a compound selected from the group consisting of acetate and methanol.

5. The method of claim 1, wherein the biomass contains an activated sludge bacterial community.

6. The method of claim 1, wherein the one or more bacteria are combined with an activated sludge bacterial community taken from a wastewater treatment plant.

7. The method of claim 1, wherein the first time period is between about 30 days to about 45 days and second time period is between about 10 days to about 20 days or about 5 days to about 15 days.

8. The method of claim 1, wherein the target biodegradation percentage of CTFE oligomers, oligomer acids, and derivatives thereof, in the wastewater after exiting the first biological treatment unit ranges from about 70% to about 95% and wherein the target biodegradation percentage of CTFE oligomers, oligomer acids, and derivatives thereof, in the wastewater after exiting the second biological treatment unit ranges from about 5% to about 20%.

9. The method of claim 1, wherein the first biological treatment unit is inoculated with a cell culture containing the one or more bacteria and/or an autoclaved spent media of the cell culture containing the one or more bacteria.

10. The method of claim 1, wherein the second biological treatment unit is inoculated with an activated sludge community taken from a wastewater treatment plant.

11. The method of claim 1, wherein the first biological treatment unit and the second biological treatment unit are connected in series or integrated into one unit.

12. The method of claim 1, wherein the first biological treatment unit and/or the second biological treatment unit are connected to an incineration tower.

13. The method of claim 1, wherein the first biological treatment unit and/or the second biological treatment unit are linked to a wastewater outlet flow from a commercial or industrial site.

14. The method of claim 1, wherein the first biological treatment unit and/or the second biological treatment unit contain a chemical monitoring system.

15. The method of claim 1, wherein the wastewater contained within the first biological treatment unit or the second biological treatment unit are tested for residual CTFE oligomers, oligomer acids, derivatives thereof, and degradation byproducts through automated sample removal and/or sample testing or manual sample removal and/or sample testing.

16. A method of biodegrading a chlorotrifluoroethylene (CTFE) oligomer acid, the method comprising:
combining the CTFE oligomer acid with heme b in a medium comprising sodium sulfide under anaerobic conditions; and
maintaining the combination at anaerobic conditions for a period of time sufficient to achieve defluorination of the CTFE oligomer acid.

17. The method of claim 16, wherein the medium comprising sodium sulfide is BAV1.

18. The method of claim 17, wherein combining the CTFE oligomer acid with heme b in a medium comprising sodium sulfide under anaerobic conditions comprises:
adding the heme b to the BAV1;
autoclaving the BAV1 containing the heme b; and
adding the CTFE oligomer acid to the BAV1 after autoclaving the BAV1 containing the heme b.

19. A method of biodegrading chlorotrifluoroethylene (CTFE) oligomers, the method comprising:
treating the CTFE oligomer using an advanced oxidation process to produce an AOP treatment product, the process comprising:
combining the CTFE oligomer with a surfactant in persulfate; and
heating the combination at basic pH for one to four hours;
adding the AOP treatment product into a biomass inside a biological treatment unit maintained under anaerobic conditions;
depositing wastewater into the biological treatment unit;
retaining the wastewater in the biological treatment unit for a time period; and
testing the wastewater to determine the concentration of the CTFE oligomer and/or breakdown products from the biological degradation of the CTFE oligomer.

20. The method of claim 19, wherein the biomass contains an activated sludge bacterial community.
